(19) United States
(12) Patent Application Publication
(10) Pub. No.: US 2023/0194947 A1
(43) Pub. Date: Jun. 22, 2023

(54) LIGHT PATH CONTROL MEMBER AND DISPLAY DEVICE INCLUDING SAME

(71) Applicant: LG INNOTEK CO., LTD., Seoul (KR)

(72) Inventors: Jong Sik LEE, Seoul (KR); Byung Sook KIM, Seoul (KR); Jun LEE, Seoul (KR); Mun Yeong SON, Seoul (KR); Jin Gyeong PARK, Seoul (KR)

(73) Assignee: LG INNOTEK CO., LTD., Seoul (KR)

(21) Appl. No.: 17/925,888

(22) PCT Filed: Apr. 19, 2021
(86) PCT No.: PCT/KR2021/004844

§ 371 Date: Nov. 17, 2022

(30) Foreign Application Priority Data
May 18, 2020 (KR) 10-2020-0059295
Jun. 9, 2020 (KR) 10-2020-0069434

(51) Int. Cl. G02F 1/1679; G02F 1/167; G02F 1/16755

(52) U.S. Cl. CPC G02F 1/1679; G02F 1/167; G02F 1/16755

(57) ABSTRACT

A light path control member according to an embodiment comprises: a first substrate; a first electrode disposed on the first substrate; a second substrate disposed on the first substrate; a second electrode disposed below the second substrate; and a light conversion unit disposed between the first electrode and the second electrode, wherein the light conversion unit includes a partition wall part and an accommodation part which are alternately arranged, a sealing part is disposed on the outer surface of the light conversion unit, and the sealing part contains the same material as at least one among the first substrate and the second substrate.

### TECHNICAL FIELD

An embodiment relates to a light path control member, and to a display device including the same.

### BACKGROUND ART

A light blocking film blocks transmitting of light from a light source, and is attached to a front surface of a display panel which is a display device used for a mobile phone, a notebook, a tablet PC, a vehicle navigation device, a vehicle touch, etc., so that the light blocking film adjusts a viewing angle of light according to an incident angle of light to express a clear image quality at a viewing angle needed by a user when the display transmits a screen.

In addition, the light blocking film may be used for the window of a vehicle, building or the like to shield outside light partially to prevent glare, or to prevent the inside from being visible from the outside.

That is, the light blocking film may be a light path control member that controls the movement path of light to block light in a specific direction and transmit light in a specific direction. Accordingly, it is possible to control the viewing angle of the user by controlling a transmission angle of the light by the light blocking film.

Meanwhile, such a light blocking film may be divided into a light blocking film that can always control the viewing angle regardless of the surrounding environment or the user's environment and a switchable light blocking film that allow the user to turn on/off the viewing angle control according to the surrounding environment or the user's environment.

Such a switchable light blocking film may be implemented by switching a pattern part to a light transmitting part and a light blocking part by filling the inside of the pattern part with particles that may move when a voltage is applied and a dispersion liquid for dispersing the particles and by dispersing and aggregating the particles.

Since the pattern part of the light blocking film is a viscous material such as a dispersion, a sealing layer may be disposed on the outside of the light blocking film to seal and protect them. The sealing layer may be filled using a resin material.

At this time, when the resin material constituting the sealing layer is not sufficiently applied, external impurities or the like may be introduced through the gap or the dispersion may be exposed to the outside.

In addition, external impurities or the like may be introduced through pores of the resin layer that may occur during the curing process, or the dispersion may be exposed to the outside.

Accordingly, there is a problem in that the reliability of the light path control member is reduced.

Accordingly, there is a need for a light path control member having a new structure capable of solving the above problems.

### DISCLOSURE

### Technical Problem

An embodiment relates is to provide a light path control member that can be easily manufactured and has improved reliability.

### Technical Solution

A light path control member according to an embodiment comprises: a first substrate; a first electrode disposed on the first substrate; a second substrate disposed on the first substrate; a second electrode disposed below the second substrate; and a light conversion unit disposed between the first electrode and the second electrode, wherein the light conversion unit includes a partition wall part and an accommodation part which are alternately arranged, a sealing part is disposed on the outer surface of the light conversion unit, and the sealing part contains the same material as at least one among the first substrate and the second substrate.

### Advantageous Effects

The light path controlling member according to the embodiment may facilitate sealing of the light path controlling member.

In detail, the light path control member according to the embodiment does not require a separate sealing material, melts the end regions of the lower and upper substrates to form a connection region, and connects the connection regions of the lower and upper substrates to each other, thereby a sealing part may be formed on the outer surface of the light path control member.

Accordingly, since a separate sealing material is not required for the light path control member according to the embodiment, the sealing part can be easily formed while simplifying the process. In addition, since the sealing part is integrally formed with the substrate, it is possible to prevent the sealing part from being removed from the film due to poor adhesion or the like, thereby it is possible to improve reliability while improving the sealing characteristics of the light path control member.

### DESCRIPTION OF DRAWINGS

FIG. 1 is a perspective view of a light path control member according to a first embodiment.

FIGS. 2 and 3 are perspective views of a first substrate and a first electrode and a perspective view of a second substrate and a second electrode of the light path control member according to the embodiment.

FIGS. 4 to 8 are cross-sectional views taken along line A-A′ in FIG. 1.

FIGS. 9 and 10 are cross-sectional views taken along line B-B′ in FIG. 1.

FIGS. 11 and 12 are perspective views of a light path control member according to a second embodiment.

FIGS. 13 and 14 are cross-sectional views taken along line C-C′ in FIG. 11.

FIG. 15 is a cross-sectional view taken along line D-D′ in FIG. 11.

FIG. 16 is a cross-sectional view taken along line E-E′ in FIG. 12.

FIGS. 17 and 18 are other cross-sectional views taken along line B-B′ in FIG. 1.

FIGS. 19 to 29 are views for describing a method of manufacturing a light path control member according to an embodiment.

FIG. 30 is an enlarged view of area D of FIG. 10.

FIG. 31 is an enlarged view of area E of FIG. 10.

FIGS. 32 and 33 are views for comparing contact angles of examples and comparative examples.

FIGS. 34 and 35 are cross-sectional views of a display device to which a light path control member according to an embodiment is applied.

FIGS. 36 to 38 are views for describing one embodiment of the display device to which the light path control member according to the embodiment is applied.

### MODES OF THE INVENTION

Hereinafter, embodiments of the present invention will be described in detail with reference to the accompanying drawings. However, the spirit and scope of the present invention is not limited to a part of the embodiments described, and may be implemented in various other forms, and within the spirit and scope of the present invention, one or more of the elements of the embodiments may be selectively combined and replaced.

In addition, unless expressly otherwise defined and described, the terms used in the embodiments of the present invention (including technical and scientific terms) may be construed the same meaning as commonly understood by one of ordinary skill in the art to which this invention belongs, and the terms such as those defined in commonly used dictionaries may be interpreted as having a meaning that is consistent with their meaning in the context of the relevant art.

In addition, the terms used in the embodiments of the present invention are for describing the embodiments and are not intended to limit the present invention. In this specification, the singular forms may also include the plural forms unless specifically stated in the phrase, and may include at least one of all combinations that may be combined in A, B, and C when described in “at least one (or more) of A (and), B, and C”.

Further, in describing the elements of the embodiments of the present invention, the terms such as first, second, A, B, (a), and (b) may be used. These terms are only used to distinguish the elements from other elements, and the terms are not limited to the essence, order, or order of the elements.

In addition, when an element is described as being “connected”, or “coupled” to another element, it may include not only when the element is directly “connected” to, or “coupled” to other elements, but also when the element is “connected”, or “coupled” by another element between the element and other elements.

Further, when described as being formed or disposed “on (over)” or “under (below)” of each element, the “on (over)” or “under (below)” may include not only when two elements are directly connected to each other, but also when one or more other elements are formed or disposed between two elements.

Furthermore, when expressed as “on (over)” or “under (below)”, it may include not only the upper direction but also the lower direction based on one element.

Hereinafter, a light path control member according to an embodiment will be described with reference to drawings. The light path control member described below relates to a switchable light path control member driven in various modes according to electrophoretic particles moving by applying a voltage.

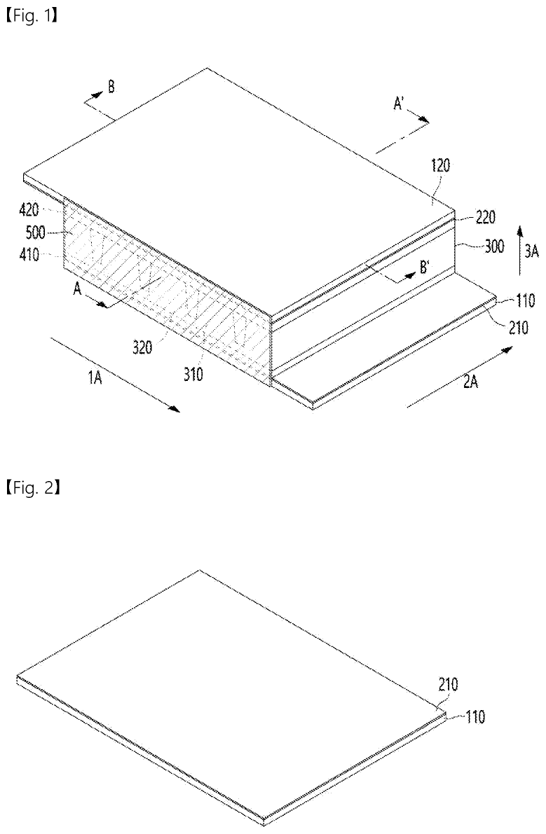

Hereinafter, a light path control member according to a first embodiment will be described with reference to FIGS. 1 to 7.

Referring to FIGS. 1 to 3, a light path control member 1000 according to an embodiment may include a first substrate 110, a second substrate 120, a first electrode 210, a second electrode 220, and a light conversion unit 300.

The first substrate 110 may support the first electrode 210. The first substrate 110 may be rigid or flexible.

In addition, the first substrate 110 may be transparent. For example, the first substrate 110 may include a transparent substrate capable of transmitting light.

The first substrate 110 may include glass, plastic, or a flexible polymer film. For example, the flexible polymer film may be made of any one of polyethylene terephthalate (PET), polycarbonate (PC), acrylonitrile-butadiene-styrene copolymer (ABS), polymethyl methacrylate (PMMA), polyethylene naphthalate (PEN), polyether sulfone (PES), cyclic olefin copolymer (COC), triacetylcellulose (TAC) film, polyvinyl alcohol (PVA) film, polyimide (PI) film, and polystyrene (PS), which is only an example, but the embodiment is not limited thereto.

In addition, the first substrate 110 may be a flexible substrate having flexible characteristics.

Further, the first substrate 110 may be a curved or bended substrate. That is, the light path control member including the first substrate 110 may also be formed to have flexible, curved, or bent characteristics. Accordingly, the light path control member according to the embodiment may be changed to various designs.

The first substrate 110 may extend in a first direction 1A, a second direction 2A, and a third direction 3A.

In detail, the first substrate 110 may include the first direction 1A corresponding to a length or width direction of the first substrate 110, a second direction 2A extending in a direction different from the first direction 1A and corresponding to the length or width direction of the first substrate 110, and a third direction 3A extending in a direction different from the first direction 1A and the second direction 2A and corresponding to a thickness direction of the first substrate 110.

For example, the first direction 1A may be defined as the length direction of the first substrate 110, the second direction 2A may be defined as the width direction of the first substrate 110 perpendicular to the first direction 1A, and the third direction 3A may be defined as the thickness direction of the first substrate 110. Alternatively, the first direction 1A may be defined as the width direction of the first substrate 110, the second direction 2A may be defined as the length direction of the first substrate 110 perpendicular to the first direction 1A, and the third direction 3A may be defined as the thickness direction of the first substrate 110.

Hereinafter, for convenience of description, the first direction 1A will be described as the length direction of the first substrate 110, the second direction 2A will be described as the width direction of the first substrate 110, and the third directions 3A will be described as the thickness direction of the first substrate 110.

The first electrode 210 may be disposed on one surface of the first substrate 110. In detail, the first electrode 210 may be disposed on an upper surface of the first substrate 110. That is, the first electrode 210 may be disposed between the first substrate 110 and the second substrate 120.

The first electrode 210 may include a transparent conductive material. For example, the first electrode 210 may include a conductive material having a light transmittance of about 80% or more. For example, the first electrode 210 may include a metal oxide such as indium tin oxide, indium zinc oxide, copper oxide, tin oxide, zinc oxide, titanium oxide, etc.

The first electrode 210 may have a thickness of 0.05 μm to 2 μm.

Alternatively, the first electrode 210 may include various metals to realize low resistance. For example, the first electrode 210 may include at least one metal of chromium (Cr), nickel (Ni), copper (Cu), aluminum (Al), silver (Ag), molybdenum (Mo). Gold (Au), titanium (Ti), and alloys thereof.

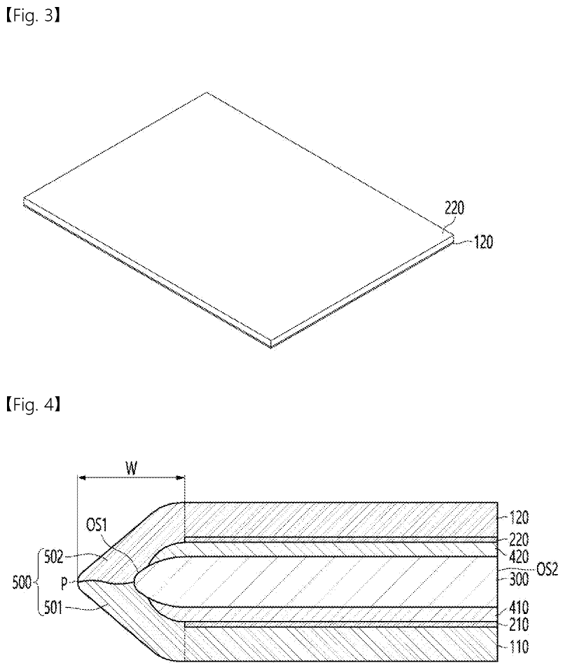

Referring to FIG. 2, the first electrode 210 may be disposed on the entire surface of one surface of the first substrate 110. In detail, the first electrode 210 may be disposed as a surface electrode on one surface of the first substrate 110. However, the embodiment is not limited thereto, and the first electrode 210 may be formed of a plurality of pattern electrodes having a uniform pattern such as a mesh or stripe shape.

For example, the first electrode 210 may include a plurality of conductive patterns. In detail, the first electrode 210 may include a plurality of mesh lines crossing each other and a plurality of mesh openings formed by the mesh lines.

Accordingly, even though the first electrode 210 includes a metal, the first electrode 210 is not visually recognized from the outside, so that visibility may be improved. In addition, the light transmittance is increased by the openings, so that the brightness of the light path control member according to the embodiment may be improved.

The second substrate 120 may be disposed on the first substrate 110. In detail, the second substrate 120 may be disposed on the first electrode 210 on the first substrate 110.

The second substrate 120 may include a material capable of transmitting light. The second substrate 120 may include a transparent material. The second substrate 120 may include a material the same as or similar to that of the first substrate 110 described above.

For example, the second substrate 120 may include glass, plastic, or a flexible polymer film. For example, the flexible polymer film may be made of any one of polyethylene terephthalate (PET), polycarbonate (PC), acrylonitrile-butadiene-styrene copolymer (ABS), polymethyl methacrylate (PMMA), polyethylene naphthalate (PEN), polyether sulfone (PES), cyclic olefin copolymer (COC), triacetylcellulose (TAC) film, polyvinyl alcohol (PVA) film, polyimide (PI) film, and polystyrene (PS). This is only an example, but the embodiment is not limited thereto.

In addition, the second substrate 120 may be a flexible substrate having flexible characteristics.

Further, the second substrate 120 may be a curved or bended substrate. That is, the light path control member including the second substrate 120 may also be formed to have flexible, curved, or bent characteristics. Accordingly, the light 1 path control member according to the embodiment may be changed to various designs.

The second substrate 120 may also extend in the first direction 1A, the second direction 2A, and the third direction 3A in the same manner as the first substrate 110 described above.

In detail, the second substrate 120 may include the first direction 1A corresponding to a length or width direction of the second substrate 120, the second direction 2A extending in a direction different from the first direction 1A and corresponding to the length or width direction of the second substrate 120, and the third direction 3A extending in the direction different from the first direction 1A and the second direction 2A and corresponding to the thickness direction of the second substrate 120.

For example, the first direction 1A may be defined as the length direction of the second substrate 120, the second direction 2A may be defined as the width direction of the second substrate 120 perpendicular to the first direction 1A, and the third direction 3A may be defined as the thickness direction of the second substrate 120.

Alternatively, the first direction 1A may be defined as the width direction of the second substrate 120, the second direction 2A may be defined as the length direction of the second substrate 120 perpendicular to the first direction 1A, and the third direction 3A may be defined as the thickness direction of the second substrate 120.

Hereinafter, for convenience of description, the first direction 1A will be described as the length direction of the second substrate 120, the second direction 2A the second direction 2A will be described as the width direction of the second substrate 120, and the third directions 3A will be described as the thickness direction of the second substrate 120.

The second electrode 220 may be disposed on one surface of the second substrate 120. In detail, the second electrode 220 may be disposed on a lower surface of the second substrate 120. That is, the second electrode 220 may be disposed on one surface of the second substrate 120 in which the second substrate 120 and the first substrate 110 face each other. That is, the second electrode 220 may be disposed to face the first electrode 210 on the first substrate 110. That is, the second electrode 220 may be disposed between the first electrode 210 and the second substrate 120.

The second electrode 220 may include a material the same as or similar to that of the first substrate 110 described above.

The second electrode 220 may include a transparent conductive material. For example, the second electrode 220 may include a conductive material having a light transmittance of about 80% or more. As an example, the second electrode 220 may include a metal oxide such as indium tin oxide, indium zinc oxide, copper oxide, tin oxide, zinc oxide, titanium oxide, etc.

The second electrode 220 may have a thickness of about 0.1 μm to about 0.5 μm.

Alternatively, the second electrode 220 may include various metals to realize low resistance. For example, the second electrode 220 may include at least one metal of chromium (Cr), nickel (Ni), copper (Cu), aluminum (Al), silver (Ag), molybdenum (Mo). gold (Au), titanium (Ti), and alloys thereof.

Referring to FIG. 3, the second electrode 220 may be disposed on the entire surface of one surface of the second substrate 120. In detail, the second electrode 220 may be disposed as a surface electrode on one surface of the second substrate 120. However, the embodiment is not limited thereto, and the second electrode 220 may be formed of a plurality of pattern electrodes having a uniform pattern such as a mesh or stripe shape.

For example, the second electrode 220 may include a plurality of conductive patterns. In detail, the second electrode 220 may include a plurality of mesh lines crossing each other and a plurality of mesh openings formed by the mesh lines.

Accordingly, even though the second electrode 220 includes a metal, the second electrode 220 is not visually recognized from the outside, so that visibility may be improved. In addition, the light transmittance is increased by the openings, so that the brightness of the light path control member according to the embodiment may be improved.

The first substrate 110 and the second substrate 120 may have sizes corresponding to each other. The first substrate 110 and the second substrate 120 may have sizes the same as or similar to each other.

In detail, a first length extending in the first direction 1A of the first substrate 110 may have a size the same as or similar to a second length L2 extending in the first direction 1A of the second substrate 120.

For example, the first length and the second length may have a size of 300 mm to 400 mm.

In addition, a first width extending in the second direction 2A of the first substrate 110 may have a size the same as or similar to a second width extending in the second direction 2A of the second substrate 120.

For example, the first width and the second width may have a size of 150 mm to 200 mm.

Alternatively, the first width extending in the second direction 2A of the first substrate 110 may be different from the second width extending in the second direction of the second substrate 120.

For example, within the above range, the first width may be larger than the second width.

In addition, a first thickness extending in the third direction 3A of the first substrate 110 may be the same as or similar to a second thickness extending in the third direction of the second substrate 120.

For example, the first thickness and the second thickness may have a size of about 0.1 μm to about 0.5 μm.

That is, the first substrate 110 and the second substrate 120 are formed to have the same or similar length, width, and thickness to each other, or the first substrate 110 and the second substrate 120 are formed to have the same length and similar thickness, and the width of the first substrate 110 may be greater than the width of the second substrate 120.

A position of a sealing layer may vary according to the sizes of the first substrate 110 and the second substrate 120.

For example, when the length, width, and thickness of the first substrate 110 and the second substrate 120 are formed to be the same or similar to each other, the sealing layer may be disposed to extend from an upper portion of the first substrate along a lower portion of the second substrate.

Alternatively, when the first substrate 110 and the second substrate 120 have different widths, the sealing layer may be disposed on a light conversion unit.

Hereinafter, for convenience of description, the first substrate 110 and the second substrate 120 will be mainly described with the same or similar length, width, and thickness.

The light conversion unit 300 may be disposed between the first substrate 110 and the second substrate 120. In detail, the light conversion unit 300 may be disposed between the first electrode 210 and the second electrode 220.

Functional layers may be disposed in an area between at least one of the area between the light conversion unit 300 and the first substrate 110 or the area between the light conversion unit 300 and the second substrate 120.

In detail, a buffer layer 410 that facilitates adhesion between the light conversion unit 300 and the first substrate 110 may be disposed between the light conversion unit 300 and the first substrate 110. In addition, an adhesive layer 420 bonding the second electrode 220 and the light conversion unit 300 may be disposed between the light conversion unit 300 and the second substrate 120.

The light conversion unit 300 may include a plurality of partition wall parts 310 and accommodation parts 320. Light conversion particles that move according to the application of a voltage may be disposed in the accommodation part 320, and the light transmitting characteristic of the light path control member may be changed by the light conversion particles.

The light path control member may include a plurality of outer surfaces. Hereinafter, for convenience of explanation, the outer surfaces to which the accommodation part 320 is exposed are defined as a first outer surface and a second outer surface, and the outer surfaces to which the partition wall part 310 located at both ends are exposed are defined as a third outer surface and a fourth outer surface.

That is, the first outer surface and the second outer surface may be outer surfaces corresponding to the outer surface in the first direction of the light path control member, and the third outer surface and the fourth outer surface may be outer surfaces corresponding to the outer surface in the second direction of the light path control member.

Accordingly, the substrate, the light conversion unit, the electrode, the buffer layer, and the adhesive layer constituting the light path control member may each include an outer surface in the above direction.

Referring to FIG. 1, the first substrate 110 and the second substrate 120 may be disposed to be misaligned from each other. That is, the third outer surface and the fourth outer surface of the first substrate 110 and the third outer surface and the fourth outer surface of the second substrate 120 may be disposed to be misaligned in the first direction 1A.

In detail, the first substrate 110 and the second substrate 120 may be disposed at positions misaligned from each other in the first direction 1A. In detail, the first substrate 110 and the second substrate 120 may be disposed so that side surfaces of the substrates are misaligned from each other.

Accordingly, the first substrate 110 may be disposed to protrude in one direction in the first direction 1A, and the second substrate 120 may be disposed to protrude in the other direction in the first direction 1A.

That is, the first substrate 110 may include a first protrusion protruding in one direction in the first direction 1A, and the second substrate 110 may include a second protrusion protruding in the other direction in the first direction 1A.

Accordingly, the light path control member 1000 may include a region where the first electrode 210 is exposed on the first substrate 110 and a region where the second electrode 220 is exposed under the second substrate 120.

That is, the first electrode 210 disposed on the first substrate 110 may be exposed at the first protrusion, and the second electrode 220 disposed under the second substrate 120 may be exposed at the second protrusion.

The first electrode 210 and the second electrode 220 exposed at the protrusions may be connected to the pad of the printed circuit board through an anisotropic conductive material, thereby the light path control member and the printed circuit board may be electrically connected.

The sealing part may be disposed on an outer surface of the light path control member. In detail, the sealing part may be disposed on an outer surface of at least one of the outer surfaces of the light path control member.

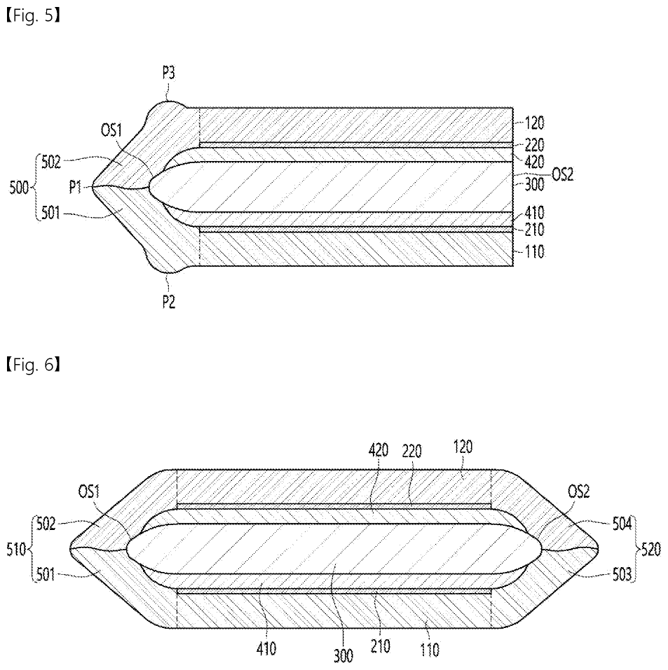

FIGS. 4 to 6 are cross-sectional views of the light path control member cut in the second direction, which is the direction of the first outer surface and the second outer surface to which the accommodating part 320 is exposed.

Referring to FIGS. 4 and 5, in the light path control member according to the first embodiment, a sealing unit 500 may be disposed on at least one of the first outer surface OS1 and the second outer surface OS2 of the light conversion unit 300.

For example, referring to FIGS. 4 and 5, the sealing part 500 may be disposed on the outer surface of any one of the first outer surface OS1 or the second outer surface OS2 of the light conversion part 300.

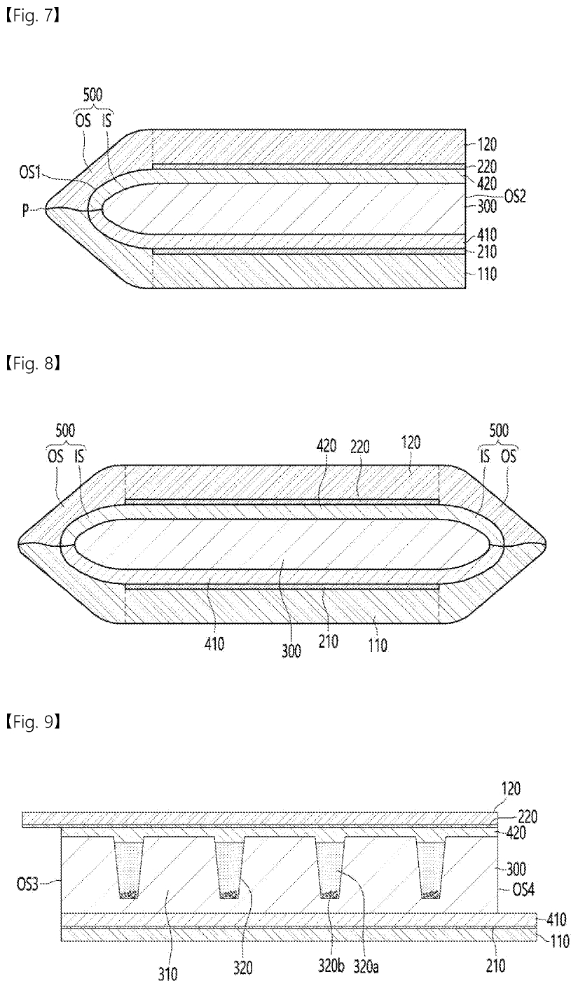

Alternatively, referring to FIG. 6, the sealing part 500 may be disposed on both the first outer surface OS1 and the second outer surface OS2 of the light conversion part 300.

Referring to FIG. 4, the sealing part 500 may include a first sealing layer 501 and a second sealing layer 502.

The first sealing layer 501 may extend from an end of the first substrate 110, and the second sealing layer 502 may extend from an end of the second substrate 120. That is, the first sealing layer 501 may extend from the first outer surface of the first substrate 110, and the second sealing layer 502 may extend from the first outer surface of the second substrate 120.

The first sealing layer 501 and the second sealing layer 502 may contact each other. In detail, the first sealing layer 501 and the second sealing layer 502 extend in a direction away from the first outer surface OS1 of the light conversion unit 300, and an upper surface of the first sealing layer 501 and a lower surface of the second sealing layer 502 may contact each other. Accordingly, the first sealing layer 501 and the second sealing layer 502 may be integrally formed with each other to form the sealing part 500.

Accordingly, the sealing part 500 may be formed in a shape in which the thickness is reduced while extending from the first outer surfaces of the first substrate 110 and the second substrate 120. That is, the thickness of the sealing part 500 is gradually reduced as it moves away from the first outer surfaces of the first substrate 110 and the second substrate 120, and a region having a thickness close to zero may be formed at the end of the sealing part 500. Accordingly, the sealing part 500 may include a protrusion P protruding in one direction from the end of the sealing part 500.

Meanwhile, referring to FIG. 5, the sealing part 500 may include a plurality of protrusions. In detail, the sealing part 500 includes a first protrusion P1 disposed at one end of the sealing part 500, a second protrusion P2 protruding toward the lower surface of the first substrate 110, and a third protrusion P3 protruding toward the top surface of the second substrate 120.

The second protrusion P2 and the third protrusion P3 may be formed according to an adhesion process of the first sealing layer 501 and the second sealing layer 502. That is, by the heat and the amount time of pressure used when bonding the first sealing layer 501 and the second sealing layer 502, a plurality of protrusions having various shapes and positions may be formed on the first sealing layer 501 and the second sealing layer 502.

The sealing part 500 may be formed to have a constant width.

A width w of the sealing part may be 2 mm or less. In detail, the width w of the sealing part may be 1 mm or less. In more detail, the width w of the sealing part may be 0.5 mm or less. In more detail. the width w of the sealing part may be 0.1 mm or less. When the width of the sealing part 500 exceeds 2 mm, the bezel width of the light path control member may be increased by the size of the sealing part.

The sealing part 500 may include the same material as the first substrate 110 and the second substrate 120. The sealing part 500 may be integrally formed with the first substrate 110 and the second substrate 120. That is, the sealing part 500, the first substrate 110, and the second substrate 120 may be integrally formed.

That is, the first sealing layer 501 may be a region of the first substrate 110, and the second sealing layer 502 may be a region of the second substrate 120. That is, the first sealing layer 501 may be integrally formed with the first substrate 110, and the second sealing layer 502 may be integrally formed with the second substrate 120.

In detail, the first electrode 210, the buffer layer 410 and the light conversion unit 300 on the first substrate 110 are removed by applying a laser of a specific wavelength to the first end region of the first substrate 110, and then the first substrate 110 may be melted by applying heat to the first end region of the first substrate 110. Accordingly, a molten region extending by melting from the first end of the first substrate 110 may be formed in the first substrate 110.

In addition, the second electrode 220, the adhesive layer 410 and the light conversion unit 300 on the second substrate 120 are removed by applying a laser of a specific wavelength to the first end region of the second substrate 120, and then the second substrate 110 may be melted by applying heat to the first end region of the second substrate 120. Accordingly, a molten region extending by melting from the first end of the second substrate 120 may be formed in the second substrate 120.

In detail, the first substrate 110 extends in the direction of the first outer surface OS1 of the light conversion unit 300, and the second substrate 120 extends in the direction of the first outer surface OS1 of the light conversion unit 300, and extension regions of the first substrate 110 and the second substrate 120 may be bonded to each other to form one sealing part 500.

Referring to FIG. 6, the sealing part 500 may include a first sealing part 510 and a second sealing part 520.

In detail, the first sealing part 510 may be disposed on the first outer surface OS1 of the light conversion part 300, and the second sealing part 520 may be disposed on the second outer surface OS2 of the light conversion part 300.

The first sealing part 510 may include a first sealing layer 501 and a second sealing layer 502.

The first sealing layer 501 may extend from a first end of the first substrate 110, and the second sealing layer 502 may extend from a first end of the second substrate 120. That is, the first sealing layer 501 may extend from the first outer surface of the first substrate 110, and the second sealing layer 502 extend from the first outer surface of the second substrate 120.

The first sealing layer 501 and the second sealing layer 502 may contact each other.

In detail, the first sealing layer 501 and the second sealing layer 502 extend in a direction away from the first outer surface OS1 of the light conversion unit 300, and the upper surface of the first sealing layer 501 and the lower surface of the second sealing layer 502 may contact each other. Accordingly, the first sealing layer 501 and the second sealing layer 502 may be integrally formed with each other to form the first sealing part 510.

Accordingly, the first sealing part 510 may be formed in a shape in which the thickness is reduced while extending from the first outer surfaces of the first substrate 110 and the second substrate 120. That is, the thickness of the sealing part 500 is decreased as it moves away from the first outer surfaces of the first substrate 110 and the second substrate 120, and a region having a thickness of 0 may be formed at the end of the sealing part 500. Accordingly, the first sealing part 510 may include a protrusion P protruding in one direction from an end of the first sealing part 510.

The second sealing part 520 may include a third sealing layer 503 and a fourth sealing layer 504.

The third sealing layer 503 may extend from a second end facing the first end of the first substrate 110, and the fourth sealing layer 504 may extend from a second end facing the first end of the second substrate 120. That is, the third sealing layer 503 may extend from the second outer surface of the first substrate 110, and the fourth sealing layer 504 may extend from the second outer surface of the second substrate 120.

The third sealing layer 503 and the fourth sealing layer 504 may contact each other. In detail, the third sealing layer 503 and the fourth sealing layer 504 extend in a direction away from the second outer surface OS2 of the light conversion unit 300, an upper surface of the third sealing layer 503 and a lower surface of the fourth sealing layer 504 may contact each other. Accordingly, the third sealing layer 503 and the fourth sealing layer 504 may be integrally formed with each other to form the second sealing portion 520.

Accordingly, the second sealing part 520 may be formed in a shape in which the thickness is reduced while extending from the second outer surfaces of the first substrate 110 and the second substrate 120. That is, the thickness of the second sealing part 520 is gradually reduced as it moves away from the second outer surfaces of the first substrate 110 and the second substrate 120, and a region having a thickness close to zero may be formed at the end of the second sealing part 520. Accordingly, the second sealing part 520 may include a protrusion P protruding in one direction from the end of the second sealing part 520.

The first sealing part 510 and the second sealing part 520 may include the same material as the first substrate 110 and the second substrate 120. The first sealing part 510 and the second sealing part 520 may be integrally formed with the first substrate 110 and the second substrate 120. That is, the first sealing part 510, the second sealing part 520, the first substrate 110, and the second substrate 120 may be integrally formed.

That is, the first sealing layer 501 and the third sealing layer 503 may be a region of the first substrate 110, and the second sealing layer 502 and the fourth sealing layer 504 may be a region of the second substrate 120. That is, the first sealing layer 501 and the third sealing layer 503 may be integrally formed with the first substrate 110, and the second sealing layer 502 and the fourth sealing layer 504 may be integrally formed with the second substrate 120.

In detail, the first substrate 110 extends from the first outer surface OS1 and the second outer surface OS2 of the light path control member, the second substrate 120 extends from the first outer surface OS1 and the second outer surface OS2 of the light path control member, the extension regions of the first substrate 110 and the second substrate 120 may be bonded to each other to form a first sealing part 510 and a second sealing part 520.

FIGS. 7 and 8 are other cross-sectional views of the light path control member cut in the second direction, which is the direction of the first outer surface and the second outer surface to which the accommodating part 320 is exposed.

Referring to FIGS. 7 and 8, the sealing part 500 may include an inner sealing part and an outer sealing part.

In detail, the sealing part 500 may include the inner sealing part IS disposed on at least one of the first outer surface OS1 and the second outer surface OS2 of the light conversion unit 300; and the outer sealing part OS disposed on at least one of the first outer surface and the second outer surface of the inner sealing part IS.

The inner sealing part IS may extend from an outer surface of at least one of a first outer surface and a second outer surface of the buffer layer 410 and the adhesive layer 420.

That is, a sealing layer extending from the first outer surface of the buffer layer 410 and a sealing layer extending from the first outer surface of the adhesive layer 420 may be adhered to each other to form an inner sealing part.

In addition, a sealing layer extending from the second outer surface of the buffer layer 410 and a sealing layer extending from the second outer surface of the adhesive layer 420 may be adhered to each other to form an inner sealing portion.

That is, the inner sealing part IS may include the same material as at least one of the buffer layer 410 and the adhesive layer 420. That is, the inner sealing part IS may be integrally formed with at least one of the buffer layer 410 and the adhesive layer 420.

In addition, the outer sealing part OS may extend from at least one of the first and second outer surfaces of the first substrate 110 and the second substrate 120.

That is, the sealing layer extending from the first outer surface of the first substrate 110 and the sealing layer extending from the first outer surface of the second substrate 120 may be adhered to each other to form an outer sealing part.

In addition, the sealing layer extending from the second outer surface of the first substrate 110 and the sealing layer extending from the second outer surface of the second substrate 120 may be adhered to each other to form an outer sealing portion.

That is, the outer sealing part OS may include the same material as at least one of the first substrate 110 and the second substrate 120. That is, the outer sealing part OS may be integrally formed with at least one of the first substrate 110 and the second substrate 120.

Accordingly, in the light path control member according to the embodiment, a sealing part of two layers may be disposed on the outer surface of the light conversion unit 300. Therefore, even if a crack occurs in one sealing part, it is possible to prevent the inflow of impurities that may penetrate into the light converting unit 300 through the other sealing part, so that the reliability of the light path control member can be improved.

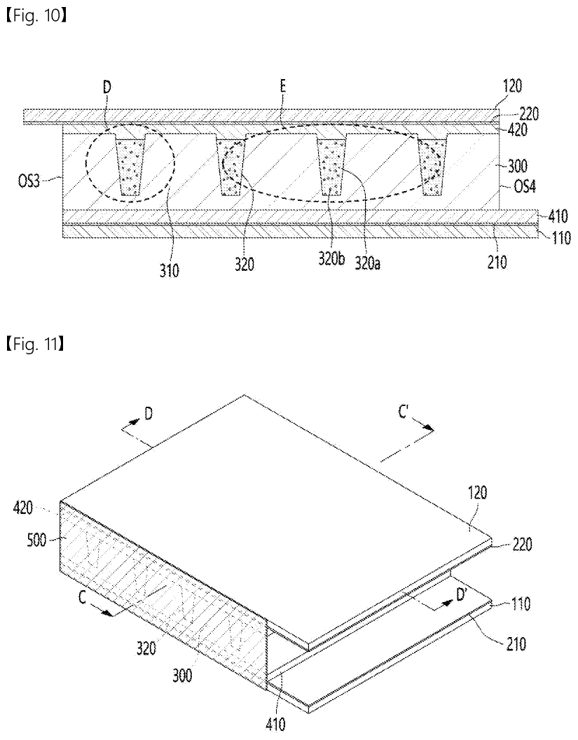

FIGS. 9 and 10 are cross-sectional views of the light path control member cut in the first direction, which is the extension direction of the third outer surface and the fourth outer surface to which the partition wall part located at both ends is exposed.

Referring to FIGS. 9 and 10, the light conversion unit 300 may include a partition wall part 310 and accommodation part 320.

The partitioning part 310 may be defined as a partitioning part dividing the accommodation part. That is, the partitioning part 310 may transmit light as a barrier region dividing a plurality of accommodation parts. In addition, the accommodation part 320 may be defined as a variable region where the accommodation part 320 is switched to a light blocking part and a light transmitting part by applying a voltage.

The partitioning part 310 and the accommodation part 320 may be alternately disposed with each other. The partitioning part 310 and the accommodation part 320 may be disposed to have different widths. For example, a width of the partitioning part 310 may be greater than that of the accommodation part 320.

The partitioning part 310 and the accommodation part 320 may be alternately disposed with each other. In detail, the partitioning part 310 and the accommodation part 320 may be alternately disposed with each other. That is, each of the partitioning parts 310 may be disposed between the accommodation parts 320 adjacent to each other, and each of the accommodation parts 320 may be disposed between the adjacent partitioning parts 310.

The partitioning part 310 may include a transparent material. The partitioning part 310 may include a material that may transmit light.

The partitioning part 310 may include a resin material. For example, the partitioning part 310 may include a photo-curable resin material. As an example, the partitioning part 310 may include a UV resin or a transparent photoresist resin. Alternatively, the partitioning part 310 may include urethane resin or acrylic resin.

The partitioning part 310 may transmit light incident on any one of the first substrate 110 and the second substrate 120 toward another substrate.

For example, in FIGS. 9 and 10, light may be emitted from the first substrate 110 by a light source disposed under the first substrate 110, and the light may be incident toward the second substrate 120. In this case, the partitioning part 310 may transmit the light, and the transmitted light may move toward the second substrate 120.

The accommodation part 320 may include the dispersion liquid 320a and the light conversion particles 320b. In detail, the accommodation part 320 may be filled by injecting the dispersion liquid 320a. A plurality of light conversion particles 320b may be dispersed in the dispersion liquid 320a.

The dispersion liquid 320a may be a material for dispersing the light conversion particles 320b. The dispersion liquid 320a may include a transparent material. The dispersion liquid 320a may include a non-polar solvent. In addition, the dispersion liquid 320a may include a material capable of transmitting light. For example, the dispersion liquid 320a may include at least one of a halocarbon-based oil, a paraffin-based oil, and isopropyl alcohol.

The light conversion particles 320b may be disposed to be dispersed in the dispersion liquid 320a. In detail, the plurality of light conversion particles 320b may be disposed to be spaced apart from each other in the dispersion liquid 320a.

The light conversion particles 320b may include a material capable of absorbing light. That is, the light conversion particles 320b may be light absorbing particles. The light conversion particles 320b may have a color. For example, the light conversion particles 320b may have a black-based color. As an example, the light conversion particles 320b may include carbon black.

The light conversion particles 320b may have a polarity by charging surfaces thereof. For example, the surfaces of the light conversion particles 320b may be charged with a negative (−) charge. Accordingly, the light conversion particles 320b may move toward the first electrode 210 or the second electrode 220 by applying a voltage.

The light transmittance of the accommodation part 320 may be changed by the light conversion particles 320b. In detail, the accommodation part 320 may be switched to the light blocking part and the light transmitting part by changing the light transmittance due to the movement of the light conversion particles 320b. That is, the accommodation part 320 may change the transmittance of light passing through the accommodation part 320 by dispersion liquid and aggregation of the light conversion particles 320b disposed inside the dispersion liquid 320a.

For example, the light path control member according to the embodiment may be converted from a first mode to a second mode or from the second mode to the first mode by a voltage applied to the first electrode 210 and the second electrode 220.

In detail, in the light path control member according to the embodiment, the accommodation part 320 becomes the light blocking part in the first mode, and light of a specific angle may be blocked by the accommodation part 320. That is, a viewing angle of the user viewing from the outside is narrowed, so that the light path control member may be driven in a privacy mode.

In addition, in the light path control member according to the embodiment, the accommodation part 320 becomes the light transmitting part in the second mode, and in the light path control member according to the embodiment, light may be transmitted through both the partitioning part 310 and the accommodation part 320. That is, the viewing angle of the user viewing from the outside may be widened, so that the light path control member may be driven in a share mode.

Switching from the first mode to the second mode, that is, the conversion of the accommodation part 320 from the light blocking part to the light transmitting part may be realized by movement of the light conversion particles 320b of the accommodation part 320. That is, the light conversion particles 320b may have a charge on the surfaces thereof and may move toward the first electrode or the second electrode by applying a voltage according to characteristics of the charge. That is, the light conversion particles 320b may be electrophoretic particles

In detail, the accommodation part 320 may be electrically connected to the first electrode 210 and the second electrode 220.

In this case, when a voltage is not applied to the light path control member from the outside, the light conversion particles 320b of the accommodation part 320 are uniformly dispersed in the dispersion liquid 320a, and the accommodation part 320 may block light by the light conversion particles. Accordingly, in the first mode, the accommodation part 320 may be driven as the light blocking part.

Alternatively, when a voltage is applied to the light path control member from the outside, the light conversion particles 320b may move. For example, the light conversion particles 320b may move toward one end or the other end of the accommodation part 320 by a voltage transmitted through the first electrode 210 and the second electrode 220. That is, the light conversion particles 320b may move from the accommodation part 320 toward the first electrode 210 or the second electrode 220.

In detail, when a voltage is applied to the first electrode 210 and/or the second electrode 220, an electric field is formed between the first electrode 210 and the second electrode 220, and the light conversion particles 320b charged with the negative charge may move toward a positive electrode of the first electrode 210 and the second electrode 220 using the dispersion liquid 320a as a medium.

That is, when the voltage is applied to the first electrode 210 and/or the second electrode 220, as shown in FIG. 9, the light conversion particles 320b may move toward the first electrode 210 in the dispersion liquid 320a. That is, the light conversion particles 320b may move in one direction, and the accommodation part 320 may be driven as the light transmitting part.

Alternatively, when the voltage is not applied to the first electrode 210 and/or the second electrode 220, as shown in FIG. 10, the light conversion particles 320b may be uniformly dispersed in the dispersion liquid 320a to drive the accommodation part 320 as the light blocking part.

Accordingly, the light path control member according to the embodiment may be driven in two modes according to a user's surrounding environment. That is, when the user requires light transmission only at a specific viewing angle, the accommodation part is driven as the light blocking part, or in an environment in which the user requires high brightness, a voltage may be applied to drive the accommodation part as the light transmitting part.

Therefore, since the light path control member according to the embodiment may be implemented in two modes according to the user's requirement, the light path control member may be applied regardless of the user's environment.

The light path control member according to the first embodiment may easily form a sealing part for sealing and protecting the accommodation part.

That is, without forming a sealing part through a separate sealing material the first or both ends of the first substrate and the second substrate are melted, and the molten end of the first substrate and the end of the second substrate are bonded to each other to form the sealing part.

Accordingly, the separate sealing material is not required, and when the sealing material is coated, it is possible to prevent decrease of sealing properties due to coating failure. In addition, after curing the sealing material, it is possible to prevent external impurities from entering through pores remaining in the sealing material or from leaking an internal dispersion liquid to the outside.

In addition, since the outer surface of the light conversion unit may be formed by a double sealing, it is possible to effectively prevent external impurities from penetrating into the light conversion unit.

Hereinafter, a light path control member according to a second embodiment will be described with reference to FIGS. 11 to 18. In the description of the light path control member according to the second embodiment, the same components as those of the light path control member according to the first embodiment described above will be omitted, and the same reference numerals will be given to the same components

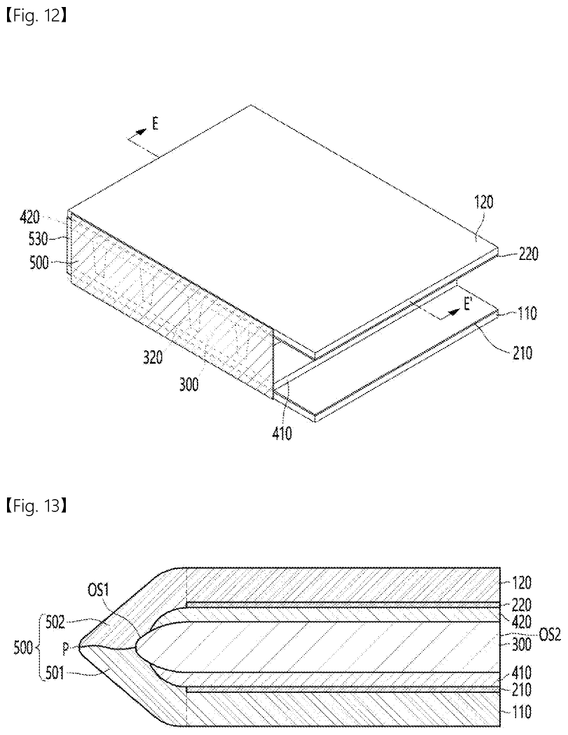

Referring to FIGS. 11 and 12, the first substrate 110 and the second substrate 120 may be disposed at positions corresponding to each other. In detail, the first substrate 110 and the second substrate 120 may be disposed so that respective side surfaces correspond to each other.

Accordingly, the first substrate 110 may be disposed to protrude in one direction of the first direction 1A, and the second substrate 120 may also protrude in one direction in the first direction 1A, that is, in the same direction as the first substrate 110.

That is, any one of the third and fourth outer surfaces of the first substrate 110 is disposed on the same vertical surface as the outer surfaces of the second substrate 120 and the light conversion unit 300, other outer surface may protrude with respect to the outer surface of the light conversion unit 300, and any one of the third and fourth outer surfaces of the second substrate 120 is disposed on the same vertical surface as the outer surfaces of the first substrate 110 and the light conversion unit 300, other outer surface may protrude with respect to the outer surface of the light conversion unit 300.

That is, the first substrate 110 may include a first protrusion that protrudes in one direction in the first direction 1A, and the second substrate may also include a second protrusion that protrudes in one direction in the first direction 1A.

That is, the first protrusion and the second protrusion may protrude in the same direction.

Accordingly, in the light path control member 1000 may include a region where the first electrode 210 is exposed on the first substrate 110; and a region where the second electrode 220 is exposed under the second substrate 120.

That is, the first electrode 210 disposed on the first substrate 110 is exposed at the first protrusion, and the second electrode 220 disposed under the second substrate 120 is exposed at the second protrusion.

The first electrode 210 and the second electrode 220 exposed at the protrusions may be connected to the pad of the printed circuit board through an anisotropic conductive material, thereby the light path control member and the printed circuit board may be electrically connected.

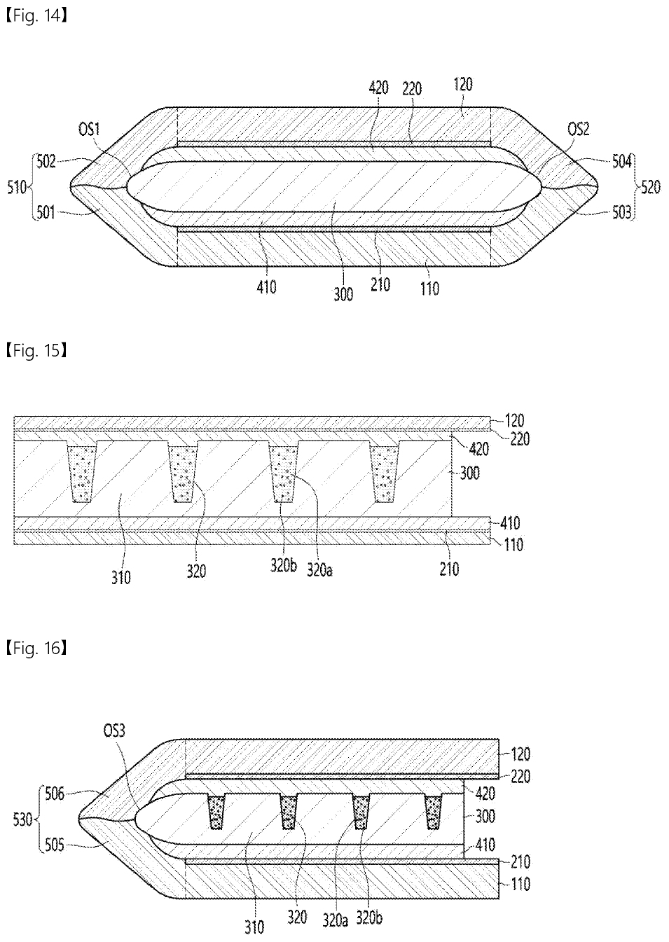

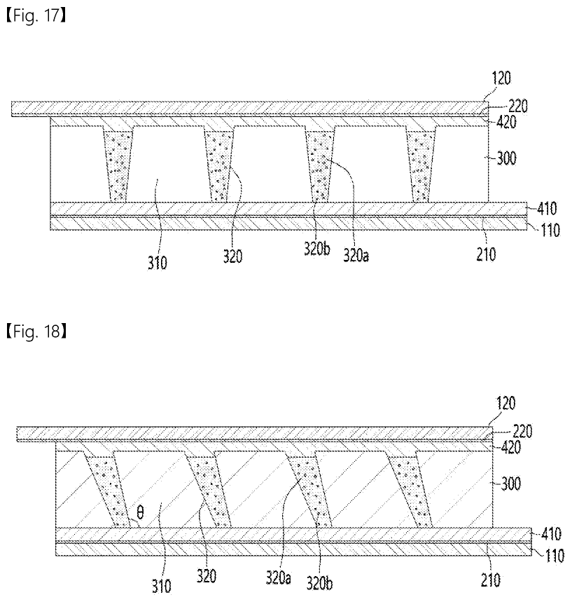

FIGS. 13 and 14 are cross-sectional views of the light path control member cut in the direction of the first outer surface OS1 and the second outer surface OS2 to which the accommodating part 320 is exposed.

Referring to FIGS. 13 and 14, in the light path control member according to the second embodiment, a sealing part 500 may be disposed on an outer surface of at least one of the first outer surface OS1 and the second outer surface OS2

For example, referring to FIG. 13, the sealing part 500 may be disposed on one of the first outer surface OS1 and the second outer surface OS2.

Alternatively, referring to FIG. 14, the sealing part 500 may be disposed on both the first outer surface OS1 and the second outer surface OS2. That is, the first sealing part 510 may be disposed on the first outer surface OS1, and the second sealing part 520 may be disposed on the second outer surface OS2.

The descriptions of the sealing part 500, the first sealing part 510, and the second sealing part 520 are the same as those of the light path control member according to the first embodiment described with reference to FIGS. 4 and 5, therefore, the following description is omitted.

FIGS. 15 and 16 are cross-sectional views of the light path control member cut in direction of the third outer surface and the fourth outer surface to which the partition wall part located at both ends is exposed.

FIG. 15 is a cross-sectional view of FIG. 11, and FIG. 16 is a cross-sectional view of FIG. 12.

Referring to FIGS. 15 and 16, in the light path control member according to the second embodiment, a sealing part may be disposed on an outer surface of at least one of the third outer surface OS3 and the fourth outer surface OS4.

In detail, referring to FIG. 15, in the light path control member, a sealing part may not be disposed on the third outer surface OS3 and the fourth outer surface OS4.

Referring to FIG. 16, a sealing part may be disposed on an outer surface of at least one of the third outer surface OS3 and the fourth outer surface OS4.

For example, the light path control member may include the third outer surface OS3 to which the partition wall part 310 is exposed and the fourth outer surface OS4 defined as the electrode connection part and exposed to the first and second protrusions.

A third sealing part 530 may be disposed on the third outer surface OS3. That is, the third sealing part 530 integrally formed with the first substrate 110 and the second substrate 120 may be disposed on the third outer surface OS3.

In detail, the third sealing part 530 may include a fifth sealing layer 505 and a sixth sealing layer 506.

The fifth sealing layer 505 may extend from a third end connecting the first end and the second end of the first substrate 110, the sixth sealing layer 506 may extend from a third end connecting the first end and the second end of the second substrate 120. That is, the fifth sealing layer 505 may extend from the third outer surface of the first substrate 110, and the sixth sealing layer 506 may extend from the third outer surface of the second substrate 120

The fifth sealing layer 505 and the sixth sealing layer 506 may contact each other. In detail, the fifth sealing layer 505 and the sixth sealing layer 506 extend in a direction away from the third outer surface OS3 of the light conversion unit 300, an upper surface of the fifth sealing layer 505 and a lower surface of the sixth sealing layer 506 may contact each other. Accordingly, the fifth sealing layer 505 and the sixth sealing layer 506 may be integrally formed with each other to form the third sealing portion 530.

Accordingly, the third sealing part 530 may be formed in a shape in which the thickness is reduced while extending from the third outer surfaces of the first substrate 110 and the second substrate 120. That is, the thickness of the third sealing part 530 is gradually reduced as it moves away from the third outer surfaces of the first substrate 110 and the second substrate 120, and a region having a thickness close to zero may be formed at the end of the third sealing part 530. Accordingly, the third sealing part 530 may include a protrusion P protruding in one direction from the end of the third sealing part 530.

The third sealing part 530 may be disposed in contact with at least one of the first sealing part 510 and the second sealing part 520. For example, the third sealing part 530 may be disposed in contact with both the first sealing part 510 and the second sealing part 520. Accordingly, the first sealing part 510, the second sealing part 520, and the third sealing part 530 may be integrally formed. That is, in the light path control member, the sealing part may be disposed in all regions except for the electrode connection region.

Accordingly, it is possible to improve the sealing characteristics of the light path control member, thereby the reliability of the light path control member is improved.

The light path control member according to the third embodiment may easily form a sealing part for sealing and protecting the accommodation part.

That is, without forming a sealing part through a separate sealing material the first or both ends of the first substrate and the second substrate are melted, and the molten end of the first substrate and the end of the second substrate are bonded to each other to form the sealing part.

Accordingly, the separate sealing material is not required, and when the sealing material is coated, it is possible to prevent decrease of sealing properties due to coating failure. In addition, after curing the sealing material, it is possible to prevent external impurities from entering through pores remaining in the sealing material or from leaking an internal dispersion liquid to the outside.

In addition, by disposing the sealing part in all the outer surface areas except for the electrode connection area, the sealing characteristics of the light path control member may be improved.

Meanwhile, the accommodation part may be disposed in a different shape in consideration of driving characteristics and the like.

Referring to FIG. 17, in the light path control member according to another embodiment, both ends of an accommodation part 320 may be disposed in contact with a buffer layer 410 and an adhesive layer 420 unlike FIGS. 9 and 10.

For example, a lower portion of the accommodation part 320 may be disposed in contact with the buffer layer 410, and an upper portion of the accommodation part 320 may be disposed in contact with the adhesive layer 420.

Accordingly, a distance between the accommodation part 320 and the first electrode 210 may be reduced, so that the voltage applied from the first electrode 210 may be smoothly transmitted to the accommodation part 320.

Accordingly, a moving speed of the light conversion particles 320b inside the accommodation part 320 may be improved, and thus the driving characteristics of the light path control member may be improved.

In addition, referring to FIG. 18, in the light path control member according to the embodiment, unlike FIGS. 9 and 10, the accommodation part 320 may be disposed while having a constant inclination angle θ.

In detail, referring to FIG. 18, the accommodation part 320 may be disposed to have an inclination angle θ of greater than 0° to less than 90° with respect to the first substrate 110. In detail, the accommodation part 320 may extend upward while having an inclination angle θ of greater than 0° to less than 90° with respect to one surface of the first substrate 110.

Accordingly, when the light path control member is used together with a display panel, more caused by an overlapping phenomenon between a pattern of the display panel and the accommodation part 320 of the light path control member may be alleviated, thereby improving user visibility.

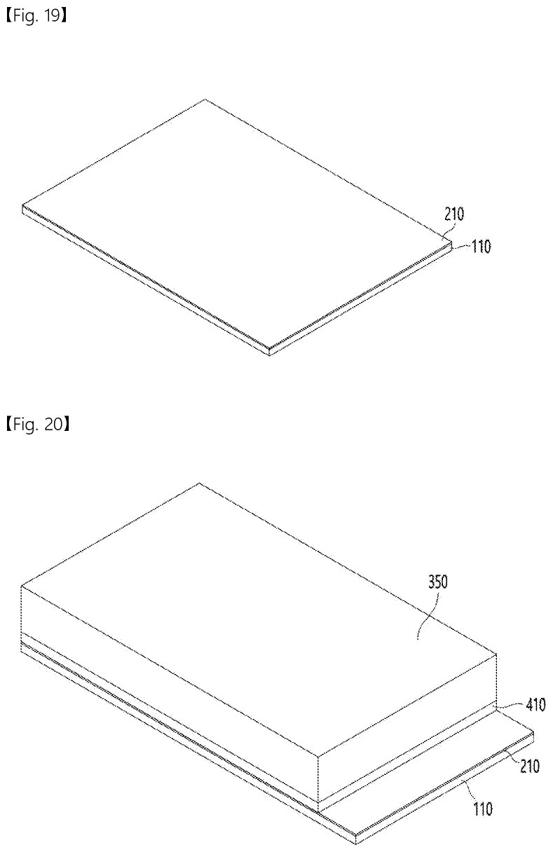

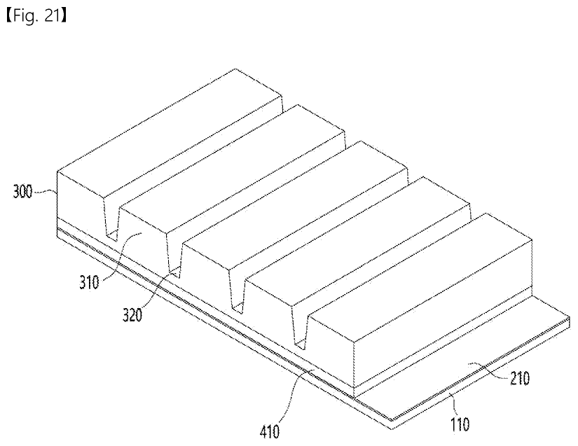

Hereinafter, a method of manufacturing the light path control member according to the embodiment will be described with reference to FIGS. 19 to 29.

Referring to FIG. 19, a first substrate 110 and an electrode material for forming a first electrode are prepared. Then, the first electrode may be formed by coating or depositing the electrode material on one surface of the first substrate. In detail, the electrode material may be formed on the entire surface of the first substrate 110. Accordingly, the first electrode 210 formed as a surface electrode may be formed on the first substrate 110.

Subsequently, referring to FIG. 20, a resin layer 350 may be formed by coating a resin material on the first electrode 210. In detail, the resin layer 350 may be formed by applying a urethane resin or an acrylic resin on the first electrode 210.

In this case, before disposing the resin layer 350, a buffer layer 410 may be additionally disposed on the first electrode 210. In detail, by disposing the resin layer 350 on the buffer layer 410 after disposing the buffer layer 410 having good adhesion to the resin layer 350 on the first electrode 210, it is possible to improve the adhesion of the resin layer 350.

For example, the buffer layer 410 may include an organic material including a lipophilic group such as —CH—, an alkyl group, etc. Having good adhesion to the electrode and a hydrophilic group such as —NH, —OH, —COOH, etc. Having a good adhesion to the resin layer 410.

The resin layer 350 may be disposed on a partial region of the first substrate 110. That is, the resin layer 350 may be disposed in an area smaller than that of the first substrate 110. Accordingly, a region where the resin layer 350 is not disposed and the first electrode 210 is exposed may be formed on the first substrate 110. In addition, when the buffer layer 410 is disposed on the first electrode 210, a region where the buffer layer 410 is exposed may be formed.

Subsequently, referring to FIG. 21, the resin layer 350 may be patterned to form a plurality of partitioning parts 310 and a plurality of accommodation parts 320 in the resin layer 350. In detail, an engraved portion may be formed in the resin layer 350 to form an engrave-shaped accommodation part 320 and the emboss-shaped partitioning part 310 between the engraved portions.

Accordingly, the light conversion unit 300 including the partitioning part 310 and the accommodation part 320 may be formed on the first substrate 110.

In addition, the buffer layer 410 exposed on the first electrode 210 may be removed to expose the first electrode 210 in a region where the first substrate 110 protrudes.

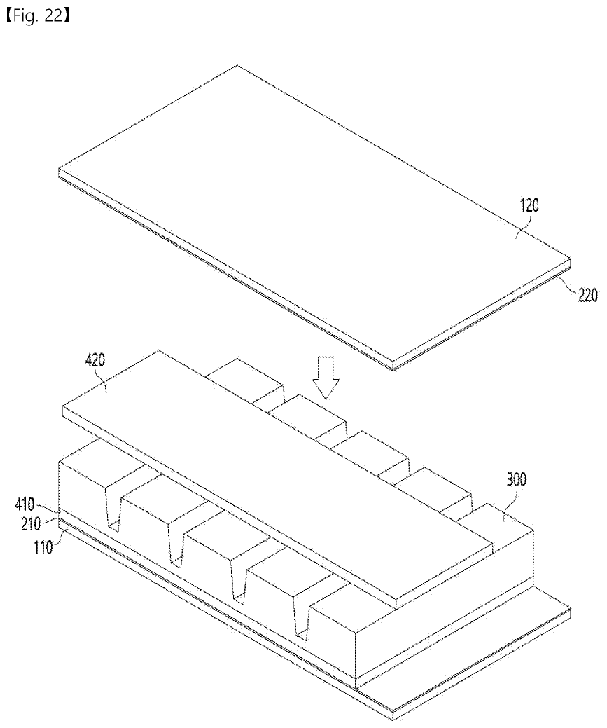

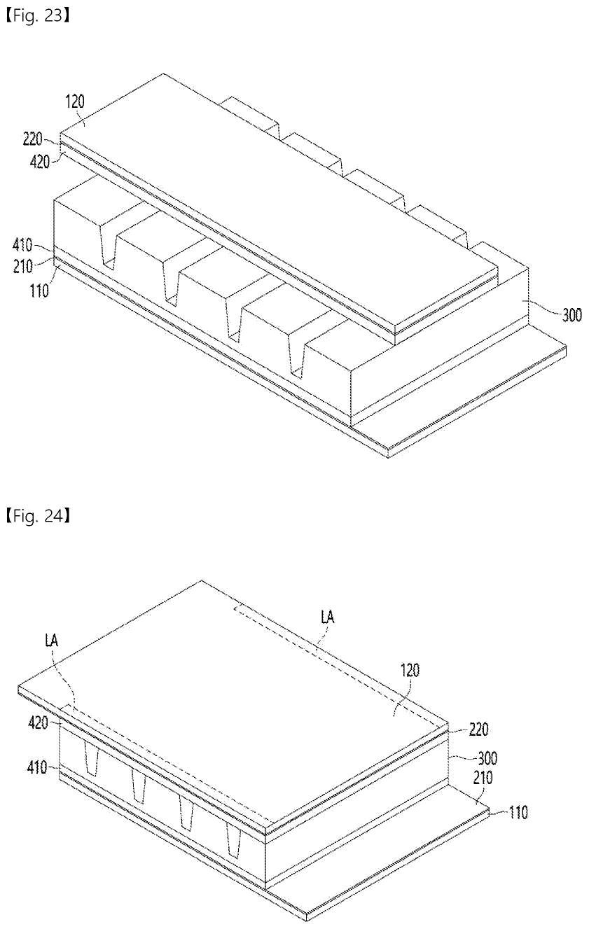

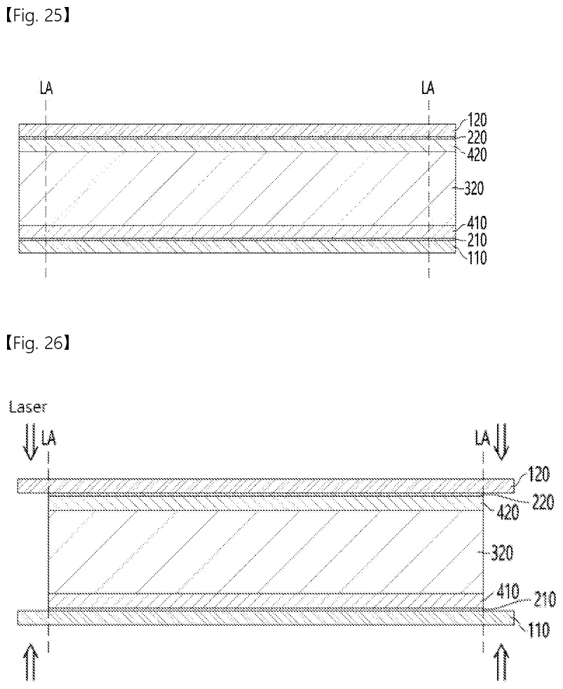

Subsequently, referring to FIGS. 22 and 23, a second electrode and an electrode material for forming a second substrate 120 and are prepared. Then, the second electrode may be formed by coating or depositing the electrode material on one surface of the second substrate. In detail, the electrode material may be formed on the entire surface of the second substrate 120. Accordingly, the second electrode 220 formed as a surface electrode may be formed on the second substrate 120.

Subsequently, an adhesive layer 420 may be formed by coating an adhesive material on the second electrode 220. In detail, a light-transmitting adhesive layer capable of transmitting light may be formed on the second electrode 220. For example, the adhesive layer 420 may include an light transparent adhesive layer OCA.

The adhesive layer 420 may be disposed on a partial region of the light conversion unit 300. That is, the adhesive layer 420 may be disposed in an area smaller than that of the light conversion unit 300. Accordingly, a region where the adhesive layer 410 is not disposed and the light conversion unit 300 is exposed may be formed on the light conversion unit 300.

Subsequently, the first substrate 110 and the second substrate 120 may be adhered. In detail, the second substrate 120 may be disposed on the light conversion unit 300, and the second substrate 120 and the light conversion unit 300 may be adhered through the adhesive layer 420 disposed under the second substrate 120.

The light conversion unit 300 and the second substrate 120 may be sequentially stacked in the thickness direction of the first substrate 110, the light conversion unit 300, and the second substrate 120.

In this case, since the second substrate 120 is disposed in a size smaller than the size of the resin layer 350, a plurality of partitioning parts 310 and accommodation parts 320 may be exposed in a region where the second substrate 120 is not disposed on the light conversion unit 300.

In detail, since the size of the second width extending in the second direction of the second substrate 120 is smaller than the size of the third width extending in the second direction of the resin layer 350, the plurality of partitioning parts 310 and the accommodation part 320 may be exposed in an end region of at least one of one end and the other end facing in a width direction of the resin layer 350.

Subsequently, a light conversion material may be injected between the partitioning parts 310, that is, the accommodation parts 320. In detail, an light conversion material in which light absorbing particles such as carbon black are dispersed in an electrolyte solvent including a paraffinic solvent and the like may be injected between the partitioning parts, that is, the accommodation parts 320. That is, the light conversion material including the above-described dispersion liquid may be injected into the accommodation part.

For example, after disposing a dam extending in a length direction of the light conversion unit 300 on the accommodation part and the partitioning part of the light conversion unit 300 on which the second substrate 120 is not disposed, the electrolyte solvent may be injected into the accommodation part 320 by a capillary injection method between the dam and a side surface of the light conversion unit 300.

Subsequently, referring to FIG. 24, one light path control member may be manufactured by cutting the light conversion unit 300. In detail, the light conversion unit 300 may be cut in the length direction of the light conversion unit 300. That is, a bonded light path control member of FIG. 20 may be cut in the longitudinal direction of the light path control member. A plurality of light path control members may be formed by the cutting process, and FIG. 24 is a view showing one of the plurality of light path control members.

Subsequently, referring to FIGS. 25 to 28, the first substrate 110 and the second substrate 120 may be melted.

First, referring to FIG. 25, a laser irradiation area LA to irradiate a laser to both ends of the first substrate 110 and the second substrate is determined.

Then, referring to FIG. 26, the laser may be irradiated to the area LA. At this time, by irradiating a laser of a specific wavelength, the first substrate 110 and the second substrate 120 remain, and the accommodation part 320, the first and second electrodes 210 and 220, the buffer layer 410, and the adhesive layer 420 between the first substrate 110 and the second substrate 120 may be removed.

Accordingly, materials between the first substrate 110 and the second substrate 120 may be removed, and an empty space may be formed between the first substrate 110 and the second substrate 120.

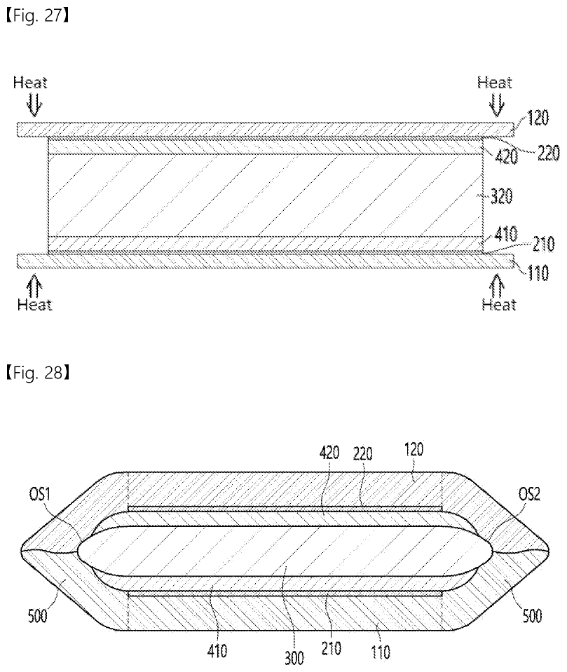

Then, referring to FIG. 27, heat may be applied to the first substrate 110 and the second substrate 120 by irradiating the laser to the area LA. In detail, the first substrate 110 and the second substrate 120 may be melted by applying heat equal to or higher than the melting temperature of the first substrate 110 and the second substrate 120.

Accordingly, referring to FIG. 28, the end regions of the first substrate 110 and the second substrate 120 are molten, and the molten regions of the first substrate 110 and the second substrate 120 are connected to each other, thereby the sealing part 500 surrounding the outer surface of the light path control member may be formed.

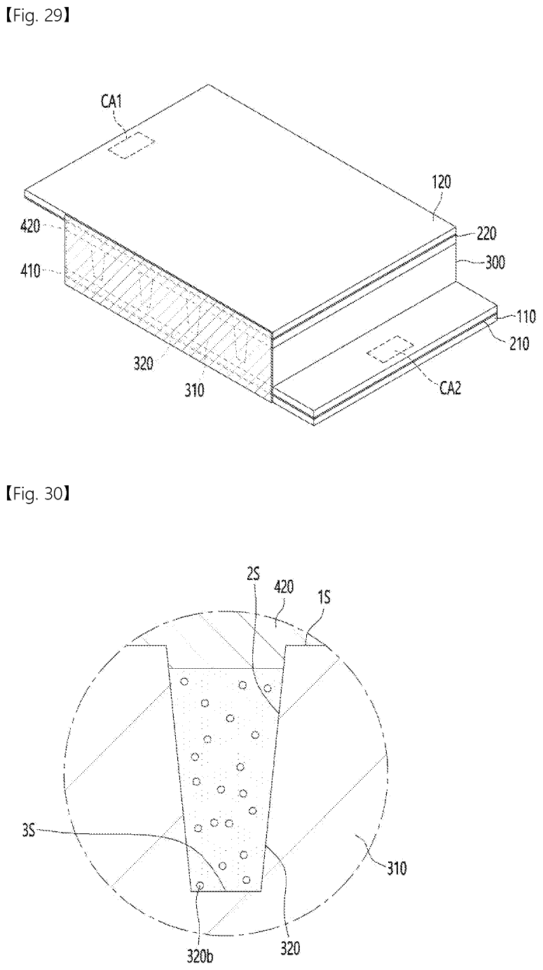

Subsequently, referring to FIG. 29, a first connection area CA1 and a second connection area CA2 for connecting an external printed circuit board may be formed in the protruding areas of the first substrate 110 and the second substrate 120, respectively.

Hereinafter, an light path control member according to another embodiment will be described with reference to FIGS. 30 to 33.

FIG. 30 is an enlarged view of a region D of FIG. 10.

Referring to FIG. 30, the light conversion unit 300 may include a plurality of surfaces. In detail, the light conversion unit 300 may include a first surface 1S, a second surface 2S, and a third surface 3S. For example, the light conversion unit 300 may include a first surface 1S defined as the upper surface of the partition wall part 310, a second surface 2S defined as an inner surface of the accommodation part 320, and a the third surface 3S defined as the bottom surface of the accommodation part 320.

The first surface 1S, the second surface 2S, and the third surface 3S may have different contact angles when they come into contact with the light conversion material.

The light conversion material may have a first contact angle θ1 with the first surface 1S. In addition, the light conversion material may have a second contact angle θ2 with the second surface 2S. Also, the light conversion material may have a third contact angle θ3 with the third surface 3S.

In detail, the light conversion material may have a first contact angle θ1 with at least one of the entire areas of the first surface 1S. Also, the light conversion material may have a second contact angle θ2 with at least one of the entire areas of the second surface 2S. In addition, the light conversion material may have a third contact angle θ3 with at least one of the entire areas of the third surface 3S.

The first contact angle θ1, the second contact angle θ2, and the third contact angle θ3 may have different sizes. In detail, the first contact angle θ1 may be greater than at least one of the second contact angle θ2 and the third contact angle θ3. In more detail, the first contact angle θ1 may be greater than the second contact angle θ2 and the third contact angle θ3.

For example, the first contact angle θ1 and the second contact angle θ2 may have a predetermined ratio. In addition, the first contact angle θ1 and the third contact angle θ3 may have a predetermined ratio.

In detail, a ratio (θ1/θ2) of the first contact angle θ1 to the second contact angle θ2 may be greater than 1. In more detail, the ratio (θ1/θ2) of the first contact angle θ1 to the second contact angle θ2 may be 1 to 10. In more detail, the ratio (θ1/θ2) of the first contact angle θ1 to the second contact angle θ2 may be 3 to 8.

Also, a ratio (θ1/θ3) of the first contact angle θ1 to the third contact angle θ3 may be greater than 1. In more detail, the ratio (θ1/θ3) of the first contact angle θ1 to the third contact angle θ3 may be 1 to 10. In more detail, the ratio (θ1/θ2) of the first contact angle θ1 to the third contact angle θ3 may be 3 to 8.

That is, the first surface 1S, the second surface 2S, and the third surface 3S may have different contact angles when they come into contact with the light conversion material.

That is, the first contact angle θ1 may be greater than the second contact angle θ2 and the third contact angle θ3. Accordingly, the upper surface of the partition wall part 310 having a larger contact angle may be relatively closer to hydrophilicity than the inner surface and the bottom surface of the accommodation part 320.

In addition, the second contact angle θ2 and the third contact angle θ3 may be smaller than the first contact angle θ1. Accordingly, the inner surface and the bottom surface of the accommodation part 320 having a smaller contact angle may be relatively closer to hydrophobicity than the upper surface of the partition wall part 310.

Accordingly, the light conversion material including the dispersion liquid 320a having a hydrophobic property has a characteristic opposite to that of the upper surface of the partition wall part 310, and thereby, when the light conversion material is filled in the accommodating part 320, the residual amount of the light conversion material remaining on the upper surface of the partition wall part 310 may be reduced.

Accordingly, it is possible to reduce the amount of the light conversion material remaining on the upper surface of the partition wall part 310, thereby the amount of the light conversion particles 320b remaining on the upper surface of the partition wall part 310 can be reduced, accordingly, since interference and blocking of light by the light conversion material can be prevented, the light path control member according to the embodiment can have improved front luminance.

Meanwhile, the first contact angle θ1 may be 10° or more. In detail, the first contact angle θ1 may be less than 10° to 50°. In more detail, the first contact angle θ1 may be 15° to 45°.

When the first contact angle θ3 is less than 10°, the first surface 1S in contact with the light conversion material, that is, the upper surface of the partition wall part 310, has a property close to hydrophobicity, accordingly, the amount of the light conversion material including the dispersion liquid 320a having hydrophobic properties remaining on the upper surface of the partition wall part 310 may be increased.

At least one of the second contact angle θ2 and the third contact angle θ3 may be less than 10°. In detail, at least one of the second contact angle θ2 and the third contact angle θ3 may be 1° to less than 10°. In more detail, at least one of the second contact angle θ2 and the third contact angle θ3 may be 4° to 6°.

When at least one of the second contact angle θ2 and the third contact angle θ3 exceeds 10°, the second surface (2S) or the third surface (3S) in contact with the light conversion material, that is, the inner surface and the bottom surface of the accommodating part 320, have properties close to hydrophilicity, thereby when the light conversion material including the dispersion liquid 320a having hydrophobic properties is filled into the accommodating part 310, a filling speed may be reduced or a filling failure may occur.

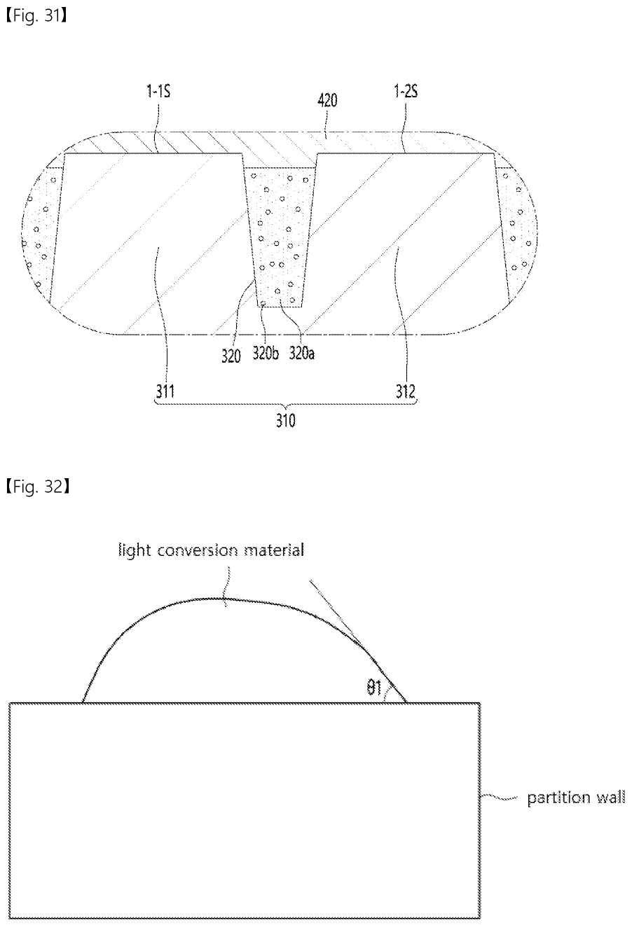

FIG. 31 is an enlarged view of area E of FIG. 10.

Referring to FIG. 31, the partition wall part 310 may include a plurality of partition wall parts. In detail, the partition wall part 310 may include a plurality of partition wall parts spaced apart from each other. That is, the partition wall parts 310 may be disposed to be spaced apart from each other by the accommodation part 320 between the partition wall parts.

For example, the partition wall part 310 may include a first partition wall part 311 and a second partition wall part 312. FIG. 3 shows that one accommodation part 320 is disposed between the first partition wall part 311 and the second partition wall part 312, but the embodiment is not limited thereto, and two or more accommodating parts 320 may be disposed between the first partition wall part 311 and the second partition wall part 312.

The first partition wall part 311 and the second partition wall part 312 may each have a contact angle when they come into contact with the light conversion material.

At this time, the contact angle of the upper surface 1-1S of the first partition wall part 311 and the dispersion liquid 320a may be equal to the contact angle of the upper surface 1-2S of the second partition wall part 312 and the dispersion liquid 320a. Alternatively, the contact angle of the upper surface 1-1S of the first partition wall part 311 and the dispersion liquid 320a may be different form the contact angle of the upper surface 1-2S of the second partition wall part 312 and the dispersion liquid 320a. That is, the contact angle of the dispersion 320a and the upper surface 1-1S of the first partition wall 311 and the contact angle of the dispersion 320a and the upper surface 1-2S of the second partition wall 312 are the same or may be similar.

For example, the size of the contact angle of the upper surface 1-1S of the first partition wall part 311 and the light conversion material may be 95% to 105% of the size of the contact angle of the upper surface 1-2S of the second partition wall part 312 and the light conversion material. That is, a difference between the contact angle of the upper surface 1-1S of the first partition wall part 311 and the light conversion material and the contact angle of the upper surface 1-2S of the second partition wall part 312 and the light conversion material may be less than 5%.

When the difference between the contact angle of the upper surface 1-1S of the first partition wall part 311 and the light conversion material and the contact angle of the upper surface 1-2S of the second partition wall part 312 and the light conversion material exceed 5%, a difference in the amount of the light conversion material remaining on the upper surface 1-1S of the first partition wall part 311 and the upper surface 1-2S of the second partition wall part 312 may increase.

Accordingly, the light transmittance of the light conversion area of the light path control member may vary for each area due to a difference in the residual amount of the light conversion material remaining on the upper surface of each of the partition wall parts.

That is, when the difference between the contact angle of the upper surface 1-1S of the first partition wall part 311 and the light conversion material and the contact angle of the upper surface 1-2S of the second partition wall part 312 and the light conversion material exceed 5%, from the outside, the difference in light transmittance in each area may appear to the user as a stain, thereby a visibility of the user may be reduced.

Therefore, in the light path control member according to the embodiment, the luminance uniformity of the light path control member may be improved by controlling the difference between the contact angle of the first partition wall part 311 and the light conversion material and the contact angle of the second partition wall part 312 and the light conversion material within 5%. Accordingly, the light path control member according to the embodiment may have improved visibility.

The light path control member according to another embodiment may have improved front luminance and luminance uniformity.

In detail, by controlling the size ratio of the contact angle of the upper surface of the partition wall part and the inner surface and/or the bottom surface of the accommodating part, when the light conversion material is filled in the accommodating part, a residual amount of the dispersion liquid that remain on the upper surface of the partition wall part may be reduced.

Accordingly, since light transmittance can be improved by minimizing light blocking by the light conversion material remaining on the upper surface of the partition wall part, the light path control member can have improved front luminance.

In addition, the light path control member may control a difference in contact angle of each of the plurality of partition wall parts and the light conversion material to a predetermined size range.

Accordingly, it is possible to minimize a difference in light transmittance for each region due to a difference in the residual amount of the light conversion material remaining in each partition wall part. Accordingly, the light path control member according to the embodiment may have improved luminance uniformity and improved visibility.

Hereinafter, the present invention will be described in more detail through the filling characteristics of the light conversion material of the light path control member according to Examples and Comparative Examples. Such Examples are merely illustrative in order to describe the present invention in more detail. Therefore, the present invention is not limited to the Examples.

### Example 1

After disposing a first electrode on a first substrate, a resin layer was formed on the first electrode. In this case, the resin layer included an acrylate-based resin.

Then, the resin layer was patterned to form a light conversion unit including a partitioning part and an accommodation part between the partitioning parts on the resin layer.

Then, the upper surface of the partition wall part was plasma-coated on the light conversion part with an output amount of a certain size.

Next, after a second electrode was disposed on a second substrate, an adhesive layer was disposed on the second electrode, and the second electrode and the light conversion unit were adhered.

Then, the light conversion material was dispensed on the upper portion of the resin layer, and the light conversion material was filled in the accommodating part.

In this case, the light conversion material included a solvent, carbon black, and a dispersant.

Subsequently, a first contact angle θ1 of the light conversion material and the upper surface of the partition wall part, a second contact angle θ2 of the light conversion material and the inner surface of the accommodating part, and a third contact angle θ3 of the light converting material and the bottom surface of the accommodating part is measured, and then the light transmittance of the light conversion unit according to the size of the first contact angle θ1 and the ratio between the first contact angle θ1, the second contact angle θ2, and the third contact angle θ3 was measured.

The contact angle was measured using Kruss' DSA100 equipment.

The contact angle was measured by injecting 1.2 μl to 3.5 μl of a light conversion material solution onto the resin layer.

### COMPARATIVE EXAMPLE

After manufacturing the light path control member in the same manner as in Example, except that the light conversion unit was not subjected to plasma treatment, the light transmittance of the light conversion unit according to the size of the first contact angle θ1 and the ratio between the first contact angle θ1, the second contact angle θ2, and the third contact angle θ3 was measured.

TABLE 1

| | | | | | Comparative | Comparative |
|---|---|---|---|---|---|---|
| | Example1 | Example2 | Example3 | Example4 | Example1 | Example2 |
| Treatment | 1 | 3 | 3 | 5 | — | 10 |
| time (min) | | | | | | |
| Output(W) | 200 | 200 | 500 | 500 | — | 500 |
| θ1/θ2 | 2 | 3 | 5 | 8 | 1 | 9 |
| θ1/θ3 | 2 | 3 | 5 | 8 | 1 | 9 |
| θ1(°) | 10.5 | 12.8 | 19.5 | 45 | 4.8 | 50 |
| Front | 80.2 | 80.7 | 82.1 | 84.3 | 78.7 | 84.5 |
| transmittance | | | | | | |
| (%) | | | | | | |

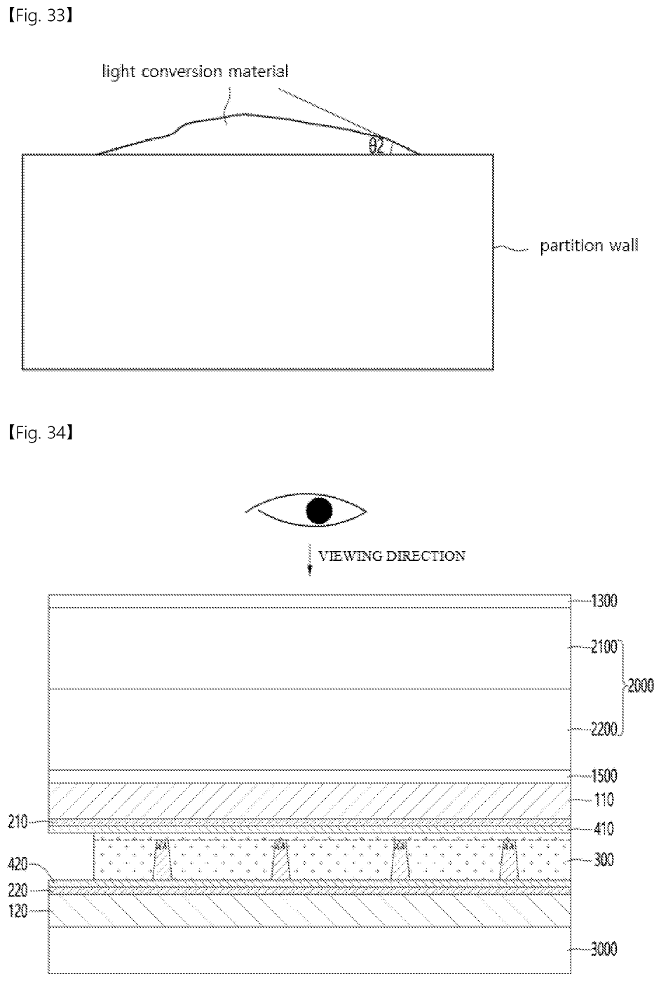

Referring to Table 1 and FIGS. 32 and 33, Examples 1 to 4 have improved front transmittance compared to Comparative Example 1. That is, when the light conversion unit is applied to the light path control member, the front luminance may be improved.

That is, referring to FIGS. 32 and 33, the contact angle θ1 of the light conversion material and the partition wall part according to the embodiments is greater than the contact angle θ2 of the light conversion material and the partition wall part according to Comparative Example 1.

Accordingly, as the contact angle of the upper surface of the partition wall part increases, the partition wall part has a relatively hydrophilic property and a residual amount of a light conversion material including a dispersion liquid having a hydrophobic property is reduced, thereby the front luminance may be improved.

On the other hand, when the contact angle of the upper surface of the partition wall part is 50 degrees or more, the increase rate of the front transmittance is small. That is, when comparing Example 4 and Comparative Example 2, Comparative Example 2 increased the treatment time more than twice as compared to Example 4, but the front transmittance increase rate is small. That is, when the contact angle of the upper surface of the partition wall part is 50 degrees or more, the process efficiency is reduced compared to the increase in the front transmittance.

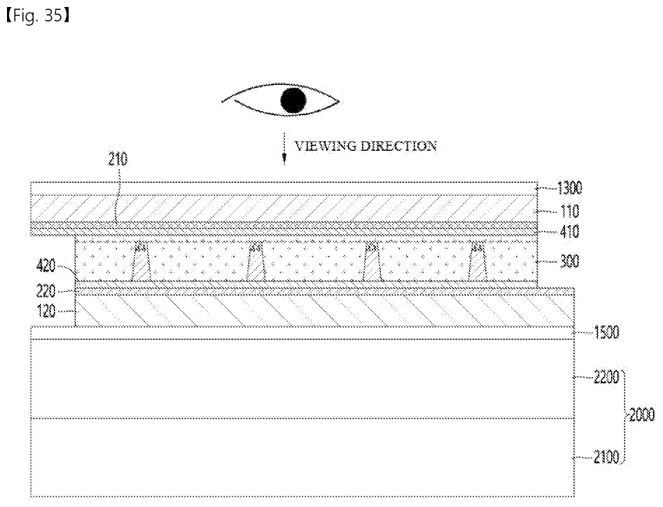

Hereinafter, referring to FIGS. 34 and 35, a display device to which a light path control member according to an embodiment is applied will be described.

Referring to FIGS. 34 and 35, a light path control member 1000 according to an embodiment may be disposed on or under a display panel 2000.

The display panel 2000 and the light path control member 1000 may be disposed to be adhered to each other. For example, the display panel 2000 and the light path control member 1000 may be adhered to each other via an adhesive layer 1500. The adhesive layer 1500 may be transparent. For example, the adhesive layer 1500 may include an adhesive or an adhesive layer including a light transparent adhesive material.

The adhesive layer 1500 may include a release film. In detail, when adhering the light path control member and the display panel, the light path control member and the display panel may be adhered after the release film is removed.

Meanwhile, referring to FIGS. 34 and 35, one end or one end and the other end of the light path control member may protrude, and the light conversion unit may not be disposed at the protruding portion. The protrusion region is an electrode connection portion in which the first electrode 210 and the second electrode 220 are exposed, and may connect an external printed circuit board and the light path control member through the electrode connection portion.

The display panel 2000 may include a first' substrate 2100 and a second' substrate 2200. When the display panel 2000 is a liquid crystal display panel, the light path control member may be formed under the liquid crystal panel. That is, when a surface viewed by the user in the liquid crystal panel is defined as an upper portion of the liquid crystal panel, the light path control member may be disposed under the liquid crystal panel. The display panel 2000 may be formed in a structure in which the first' substrate 2100 including a thin film transistor (TFT) and a pixel electrode and the second' substrate 2200 including color filter layers are bonded to each other with a liquid crystal layer interposed therebetween.

In addition, the display panel 2000 may be a liquid crystal display panel of a color filter on transistor (COT) structure in which a thin film transistor, a color filter, and a black electrolyte are formed at the first' substrate 2100 and the second' substrate 2200 is bonded to the first' substrate 2100 with the liquid crystal layer interposed therebetween. That is, a thin film transistor may be formed on the first' substrate 2100, a protective film may be formed on the thin film transistor, and a color filter layer may be formed on the protective film. In addition, a pixel electrode in contact with the thin film transistor may be formed on the first' substrate 2100. At this point, in order to improve an aperture ratio and simplify a masking process, the black electrolyte may be omitted, and a common electrode may be formed to function as the black electrolyte.

In addition, when the display panel 2000 is the liquid crystal display panel, the display device may further include a backlight unit 3000 providing light from a rear surface of the display panel 2000.

That is, as shown in FIG. 34, the light path control member may be disposed under the liquid crystal panel and on the backlight unit 3000, and the light path control member may be disposed between the backlight unit 3000 and the display panel 2000.

Alternatively, as shown in FIG. 35, when the display panel 2000 is an organic light emitting diode panel, the light path control member may be formed on the organic light emitting diode panel. That is, when the surface viewed by the user in the organic light emitting diode panel is defined as an upper portion of the organic light emitting diode panel, the light path control member may be disposed on the organic light emitting diode panel. The display panel 2000 may include a self-luminous element that does not require a separate light source. In the display panel 2000, a thin film transistor may be formed on the first' substrate 2100, and an organic light emitting element in contact with the thin film transistor may be formed. The organic light emitting element may include an anode, a cathode, and an organic light emitting layer formed between the anode and the cathode. In addition, the second' substrate 2200 configured to function as an encapsulation substrate for encapsulation may be further included on the organic light emitting element.

That is, light emitted from the display panel 2000 or the backlight unit 3000 may move from the second substrate 120 toward the first substrate 110 of the light path control member.

In addition, although not shown in drawings, a polarizing plate may be further disposed between the light path control member 1000 and the display panel 2000. The polarizing plate may be a linear polarizing plate or an external light reflection preventive polarizing plate. For example, when the display panel 2000 is a liquid crystal display panel, the polarizing plate may be the linear polarizing plate. Further, when the display panel 2000 is the organic light emitting diode panel, the polarizing plate may be the external light reflection preventing polarizing plate.

In addition, an additional functional layer 1300 such as an anti-reflection layer, an anti-glare, or the like may be further disposed on the light path control member 1000. Specifically, the functional layer 1300 may be adhered to one surface of the first substrate 110 of the light path control member. Although not shown in drawings, the functional layer 1300 may be adhered to the first substrate 110 of the light path control member via an adhesive layer. In addition, a release film for protecting the functional layer may be further disposed on the functional layer 1300.

Further, a touch panel may be further disposed between the display panel and the light path control member.

It is shown in the drawings that the light path control member is disposed at an upper portion of the display panel, but the embodiment is not limited thereto, and the light path control member may be disposed at various positions such as a position in which light is adjustable, that is, a lower portion of the display panel, or between a second substrate and a first substrate of the display panel, or the like.

In addition, it is shown in the drawings that the light conversion unit of the light path control member according to the embodiment is in a direction parallel or perpendicular to an outer surface of the second substrate, but the light conversion unit is formed to be inclined at a predetermined angle from the outer surface of the second substrate. Through this, a moire phenomenon occurring between the display panel and the light path control member may be reduced.

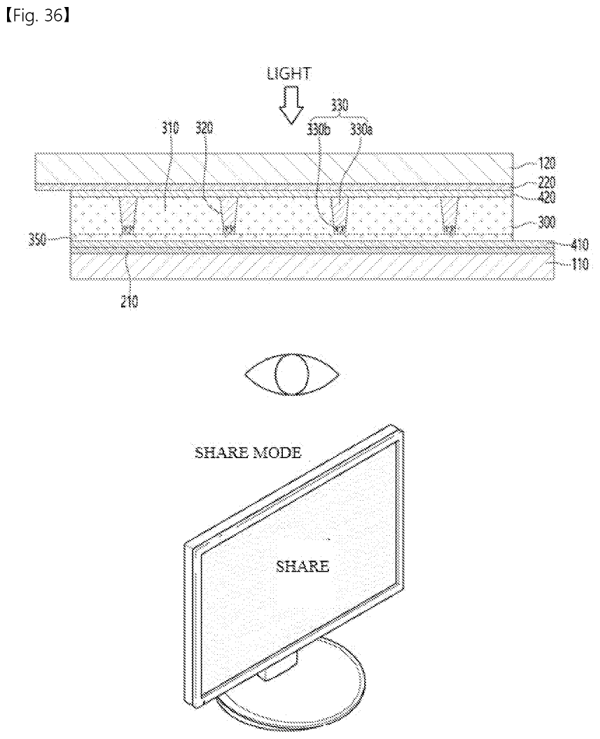

Referring to FIGS. 36 to 38, a light path control member according to an embodiment may be applied to various display devices.

Referring to FIGS. 36 to 38, the light path control member according to the embodiment may be applied to a display device that displays a display.

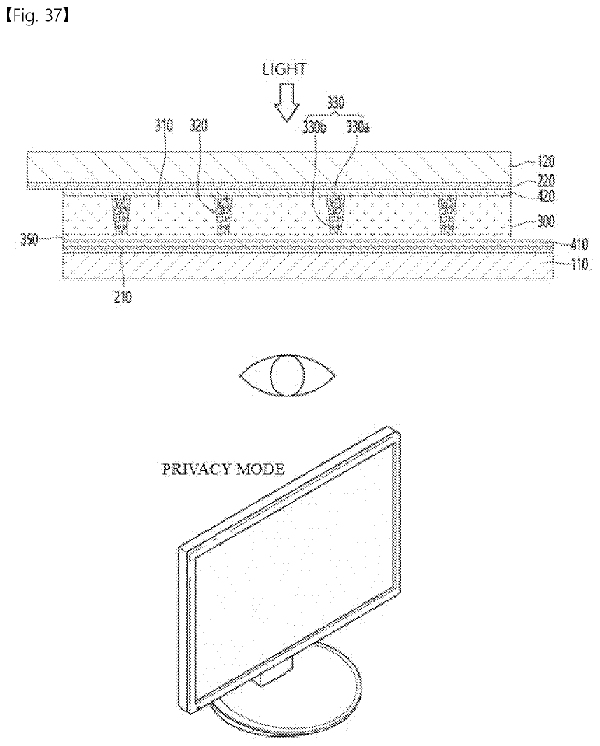

For example, when power is applied to the light path control member as shown in FIG. 36, the accommodation part functions as the light transmitting part, so that the display device may be driven in the share mode, and when power is not applied to the light path control member as shown in FIG. 37, the accommodation part functions as the light blocking part, so that the display device may be driven in the privacy mode.

Accordingly, a user may easily drive the display device in the privacy mode or a normal mode by applying power.

Light emitted from the backlight unit or the self-luminous element may move from the first substrate toward the second substrate. Alternatively, the light emitted from the backlight unit or the self-luminous element may also move from the second substrate toward the first substrate.

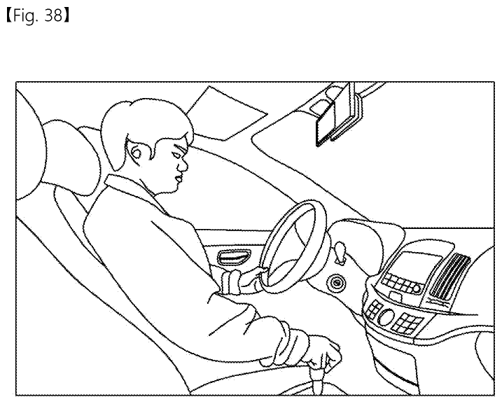

In addition, referring to FIG. 38, the display device to which the light path control member according to the embodiment is applied may also be applied inside a vehicle.

For example, the display device including the light path control member according to the embodiment may display a video confirming information of the vehicle and a movement route of the vehicle. The display device may be disposed between a driver seat and a passenger seat of the vehicle.

In addition, the light path control member according to the embodiment may be applied to a dashboard that displays a speed, an engine, an alarm signal, and the like of the vehicle.

Further, the light path control member according to the embodiment may be applied to a front glass (FG) of the vehicle or right and left window glasses.

The characteristics, structures, effects, and the like described in the above-described embodiments are included in at least one embodiment of the present invention, but are not limited to only one embodiment. Furthermore, the characteristic, structure, and effect illustrated in each embodiment may be combined or modified for other embodiments by a person skilled in the art. Accordingly, it is to be understood that such combination and modification are included in the scope of the present invention.

In addition, embodiments are mostly described above, but the embodiments are merely examples and do not limit the present invention, and a person skilled in the art may appreciate that several variations and applications not presented above may be made without departing from the essential characteristic of embodiments. For example, each component specifically represented in the embodiments may be varied. In addition, it should be construed that differences related to such a variation and such an application are included in the scope of the present invention defined in the following claims.

1-10. (canceled)

11. A light path control member comprising:
a first substrate;
a first electrode disposed on the first substrate;
a second substrate disposed on the first substrate;
a second electrode disposed under the second substrate; and
a light conversion unit disposed between the first electrode and the second electrode,
wherein the light conversion unit includes a partition wall part and an accommodation part alternately disposed,
wherein a sealing part is disposed on the outer surface of the light conversion unit, and
wherein the sealing part includes the same material as at least one of the first substrate and the second substrate.

12. The light path control member of claim 11, wherein the first substrate and the second substrate include the first direction corresponding to a length or width direction of the first substrate and the second substrate, a second direction extending in a direction different from the first direction and corresponding to the length or width direction of the first substrate and the second substrate and a third direction extending in a direction different from the first direction and the second direction and corresponding to a thickness direction of the first substrate and the second substrate,
wherein an outer surface of the light conversion unit includes a first outer surface and a second outer surface corresponding to an outer surface in the first direction of the light conversion unit; and a third outer surface and a fourth outer surface corresponding to an outer surface in the second direction of the light conversion unit, and
wherein the sealing part is disposed on the first outer surface and the second outer surface.

13. The light path control member of claim 11, wherein the sealing part includes:
a first sealing layer extending from a first outer surface of the first substrate;
a second sealing layer extending from the first outer surface of the second substrate;
a third sealing layer extending from a second outer surface of the first substrate; and
a fourth sealing layer extending from a second outer surface of the second substrate,
wherein the first sealing layer and the second sealing layer are in contact with each other, and
wherein the third sealing layer and the fourth sealing layer are in contact with each other.

14. The light path control member of claim 11, wherein the sealing part is integrally formed with the first substrate or the second substrate.

15. The light path control member of claim 12, wherein a thickness of the sealing part decreases as it moves away from the first outer surface or the second outer surface of the light conversion unit.

16. The light path control member of claim 15, wherein the sealing part includes a first protrusion disposed at an end of the sealing part.

17. The light path control member of claim 16, wherein the sealing part includes:
a second protrusion protruding from a lower surface of the first substrate; and
a third protrusion protruding from an upper surface of the second substrate.

18. The light path control member of claim 11, wherein a width of the sealing part is 2 mm or less.

19. The light path control member of claim 11, wherein the sealing part includes:
an inner sealing part disposed on an outer surface of the light conversion unit; and
an outer sealing part disposed on the inner sealing part.

20. The light path control member of claim 19, further comprising:
a buffer layer between the light conversion unit and the first electrode; and
an adhesive layer between the light conversion unit and the second electrode,
wherein the inner sealing part includes the same material as at least one of the buffer layer and the adhesive layer, and
wherein the outer sealing part includes the same material as that of at least one of the first substrate and the second substrate.

21. The light path control member of claim 11, wherein the sealing part includes:
a first sealing layer extending from an end of the first substrate; and
a second sealing layer extending from an end of the second substrate, and
wherein the first sealing layer and the second sealing layer are in direct contact.

22. The light path control member of claim 11, wherein the first sealing layer and the second sealing layer are integrally formed.

23. A display device comprising:
a display panel; and
a light path control member disposed on the display panel,
wherein the light path control member includes:
a first substrate;
a first electrode disposed on the first substrate;
a second substrate disposed on the first substrate;
a second electrode disposed under the second substrate; and
a light conversion unit disposed between the first electrode and the second electrode,
wherein the light conversion unit includes a partition wall part and an accommodation part alternately disposed,
wherein a first outer surface to which the accommodation part is exposed and a second outer surface facing the first outer surface,
wherein a sealing part is disposed on the outer surface of the light conversion unit, and
wherein the sealing part is integrally formed with at least one of the first substrate and the second substrate.

24. The display device of claim 23, wherein the sealing part includes the same material as at least one of the first substrate and the second substrate.

25. The display device of claim 23, further comprising:
a buffer layer between the light conversion unit and the first electrode; and
an adhesive layer between the light conversion unit and the second electrode,
wherein the inner sealing part includes the same material as at least one of the buffer layer and the adhesive layer, and
wherein the outer sealing part includes the same material as that of at least one of the first substrate and the second substrate.
